(19) United States
(12) Patent Application Publication
(10) Pub. No.: US 2010/0272034 A1
(43) Pub. Date: Oct. 28, 2010

(54) BASE STATION DEVICE, MOBILE STATION DEVICE, COMMUNICATION SYSTEM, CHANNEL ESTIMATION METHOD, TRANSMISSION ANTENNA DETECTION METHOD, AND PROGRAM

(75) Inventors: Tomohiro Imai, Kanagawa (JP); Atsushi Sumasu, Kanagawa (JP); Isamu Yoshii, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/679,891

(22) PCT Filed: Sep. 26, 2008
(86) PCT No.: PCT/JP2008/002700

§ 371 Date: Mar. 24, 2010

(30) Foreign Application Priority Data
Sep. 28, 2007 (JP) 2007-256111

(51) Int. Cl. H04W 72/04; H04K 1/10; H04B 1/38

(52) U.S. Cl. 370/329; 375/260; 455/561

(57) ABSTRACT

It is possible to provide a base station device, a mobile station device, a communication system, a channel estimation method, a transmission antenna detection method, and a program which can employ PVS as the SCH transmission diversity method and avoid a side lobe to improve the adjacent cell search performance. When employing the PVS on the frequency axis of the SCH in these, different precoding weights are applied between sub carrier groups so as to correlate a plurality of PSC sequences to a precoding weight matrix and identify the PSC sequence. Moreover, the number of sub carriers to be allocated to sub carrier groups is correlated to the number of transmission antennas so as to detect periodicity of the self-correlation characteristic of a reception SCH signal, thereby identifying the number of transmission antennas.

### TECHNICAL FIELD

The present invention relates to a base station apparatus, a mobile station apparatus and a communication system for performing multicarrier communication, a channel estimating method, a transmitting antenna detecting method and a program.

### BACKGROUND ART

As one of frequency selective fading counter techniques, multicarrier communication such as OFDM (Orthogonal Frequency Division Multiplexing) is gaining attention. Multicarrier communication is a technique for performing high speed transmission by transmitting data using a plurality of carriers (i.e. subcarriers) with transmission speeds reduced to an extent that frequency selective fading does not occur. In particular, with the OFDM scheme, a plurality of subcarriers on which items of data are arranged are orthogonal to each other, and therefore frequency efficiency is high among multicarrier communication. Further, the OFDM scheme is realized with a comparatively simple hardware configuration, and therefore is gaining attention particularly.

In standardization of LTE (Long Term Evolution) of 3GPP (3rd Generation Partnership Project), adopting the OFDM scheme for a downlink communication scheme is being studied. With downlink OFDM, user data and control data for a plurality of radio communication mobile station apparatuses (hereinafter “mobile stations”) are frequency-multiplexed or time-multiplexed and transmitted from a radio base station apparatus (hereinafter “base station”) to each mobile station.

As a method of transmitting control data in downlink OFDM, Non-Patent Document 1 proposes transmitting SCH (Synchronization CHannel) data at a fixed timing (for example, at an end of a frame) using a fixed bandwidth (for example, 1.25 MHz).

Note that an SCH is formed with a P-SCH (Primary-Synchronization CHannel) and an S-SCH (Secondary-Synchronization CHannel) in a downlink shared channel. P-SCH data includes a sequence that is common between all cells, and this sequence is used for timing synchronization upon cell search. Further, S-SCH data includes cell-specific transmission parameters such as scrambling code information. In cell search when each mobile station is powered on or handed over, each mobile station establishes timing synchronization by receiving P-SCH data, and acquires transmission parameters that vary between cells, by receiving S-SCH data. By so doing, each mobile station can start communication with the base station. Therefore, each mobile station first needs to detect SCH data in initial synchronization when each mobile station is powered on or handed over.

A multicarrier communication system assigns varying scramble codes between cells, to identify the cell covered by the base station apparatus, and a mobile station apparatus needs to perform cell search, that is, needs to identify the scramble code for identifying the cell when a cell is switched (i.e. handover) following movement of a mobile station apparatus or when intermittent reception is performed. 3 step cell search is a widely known cell search method (see, for example, Non-Patent Document 2).

3 step cell search detects a symbol timing (the first step), then identifies a scramble code group and detects a scramble code timing, that is, the frame timing (the second step), and identifies the scramble code (the third step). Hereinafter, the conventional 3 step cell search method will be explained using FIG. 1.

FIG. 1 shows a frame configuration in conventional 3 step cell search, In FIG. 1, the horizontal axis represents time, the vertical axis represents power, and the depth represents frequency. As shown in the same figure, SCHs that are continuous in the time domain are multiplexed with subcarriers having equal intervals in the frequency domain. SCHs with a common symbol sequence pattern are assigned to subcarriers in the same cell. Hereinafter, each step will be explained.

In the first step, utilizing the correlation characteristics of guard intervals in OFDM, a mobile station apparatus detects an FFT (Fast Fourier Transform) window timing based on the peak of the correlation value produced between a guard interval section and an effective symbol section.

In the second step, a frame timing is detected utilizing an SCH. To be more specific, the mobile station performs FFT processing of a received data signal, demultiplexes subcarriers upon which SCHs are multiplexed and finds on a per subcarrier basis the correlation in the time domain between SCH symbol sequence replicas and the received data signal subjected to FFT processing. Then, the mobile station apparatus performs power addition of the acquired correlation values between subcarriers, and detects as a frame timing a timing at which the maximum correlation value is acquired.

At this time, by preparing a plurality of SCH symbol sequences and associating SCH symbol sequences with code groups, the mobile station apparatus can detect the frame timing and identify the code group at the same time. To be more specific, the mobile station apparatus calculates on a per subcarrier basis the correlation in the time domain between a plurality of SCH symbol sequence replicas and a received data signal subjected to FFT processing. Then, the mobile station apparatus performs power addition of the resulting correlation values of SCH symbol sequences between subcarriers, and identifies an applicable code group from the SCH symbol sequence from which the maximum correlation value can be acquired. In this way, in the second step, the frame timing is detected and the code group is identified.

In the third step, a time-multiplexed CPICH (Common Pilot Channel) is extracted from the frame timing detected in the second step. Then, CPICH replicas matching all scramble codes which belong to the code group identified in the second step are generated. Then, the mobile station apparatus finds the correlation between the generated CPICH replicas and the extracted CPICH, and identifies the scramble code matching the maximum correlation value, as the scramble code for the cell.

Furthermore, for seamless transition to the 4G system, the cellular system like the 3.9G system is being standardized in 3GPP LTE, and cell search and SCH are ones of those topics. An SCH adopts a configuration of a hierarchical SCH as in W-CDMA (Wideband Code Division Multiple Access), and is formed with a P-SCH and an S-SCH. Further, the cell search procedure adopts the above-described 3 step cell search, and executes the steps of detecting a symbol timing using a P-SCH in the first step, detecting a frame timing and cell group ID using an S-SCH in the second step, detecting a cell ID using an RS (Reference Symbol) in the third step and then demodulating a P-BCH (Primary-Broadcast CHannel). When the P-BCH is demodulated, it is possible to improve the performance of demodulating the P-BCH by using a channel estimation value assuming the S-SCH as the RS.

FIG. 2 shows an example of a frame configuration of a signal transmitted from a multicarrier transmitting apparatus (hereinafter, simply “transmitter”). Note that secondary synchronization codes (“SSCs”) or secondary synchronization channels (“S-SCHs”) in the cell search steps disclosed in, for example, 3GPP specification, “TS25.214 Physical Layer Procedures (FDD),” are utilized as scramble code group identifying codes.

In the upper part of FIG. 2, frame 10 is formed with a plurality of slots, and, as shown in the lower part of FIG. 2 by magnifying the main part of frame 10, the following codes (RSs, P-BCHs, S-SCHs and P-SCHs) are added to frame 10.

As shown in the lower part of FIG. 2, a P-SCH is received first. An S-SCH is subjected to synchronized detection using the P-SCH as the phase reference. A P-BCH is demodulated by utilizing a channel estimation assuming the S-SCH as the RS. Although P-BCHs may be used upon demodulation, the accuracy of channel estimation is increased by using S-SCHs which are arranged on sub carriers more than P-BCHs.

Further, 3GPP LTE introduces MIMO (Multiple Input Multiple Output), and therefore Node B is assumed to have a plurality of transmitting antennas. In case where Node B has a plurality of transmitting antennas, it is possible to improve cell search performance by using a specific transmission diversity method for SCHs. However, UE (User Equipment) does not know the number of transmitting antennas of Node B upon synchronization when SCHs are received, and therefore transmission diversity methods for SCHs are limited. With LTE, the following transmission diversity methods are candidates.

Simulation results show that performance upon initial cell search and performance upon neighboring cell search in case where PVS (Preceding Vector Switching) is used for SCHs are good in the above transmission diversity methods, and, with LTE, there is a high possibility that PVS is applied as SCH transmission diversity.

Further, if there are a plurality of transmitting antennas of Node B, it is possible to improve cell search performance using SCH transmission diversity.

FIG. 3 shows cell search performance in case where SCH transmission diversity is used where cell search performance of PVS and FSTD (Frequency Switched Transmit Diversity) are compared according to the number of transmitting antennas (i.e. one or two). The horizontal axis represents time for cell search [ms], the vertical axis represents the percentile of UE (User Equipment), and the solid lines in this figure indicate PVS and FSTD in case where the number of transmitting antennas is one and the broken lines in this figure indicate PVS and FSTD in case where the number of transmitting antennas is two.

As shown in FIG. 3, regardless of the number of transmitting antennas of Node B, PVS provides higher cell search performance than FSTD. Further, both PVS and FSTD provide higher cell search performance in case where the number of transmitting antennas is two than in case where the number of transmitting antennas is one.

Non-Patent Document 1: 3GPP RAN WG1 LTE, Ad Hoc meeting (2005.06), R1-050590
Non-Patent Document 2: “3-Step Cell Search Performance using frequency-multiplexed SCH for Broadband Multi-carrier CDMA Wireless Access,” (Hanada, Atarashi, Higuchi, Sawahashi), TECHNICAL REPORT OF IEICE NS2001-90, RCS2001-91 (2001-07), pp. 73-78

### DISCLOSURE OF INVENTION

### Problems to be Solved by the Invention

As described above, if PVS can be used as the SCH transmission diversity method, it is possible to improve performance upon cell search. However, PVS provides beam forming gain by combining channels, and therefore cannot estimate a channel from each transmitting antenna using an S-SCH and limits transmission diversity methods to transmission diversity methods that can be used by P-BCHs. Therefore, SCH transmission diversity methods using PVS have not been realized.

Further, with 3GPP LTE, Node B is assumed to have a plurality of transmitting antennas. If Node B has a plurality of transmitting antennas, it is possible to improve performance upon cell search by using SCH transmission diversity. However, UE does not know the number of transmitting antennas of Node B upon synchronization when SCHs are received, and therefore SCH transmission diversity methods are limited. Information that UE has in advance relates to, for example, TSTD (Time Switched Transmit Diversity), FSTD, CDD (Cyclic Delay Diversity) and PVS, and UE does not have information about the number of transmitting antennas. Further, PVS that provides an advantage for improving performance upon cell search is not applicable for the above-described reason.

It is therefore an object of the present invention to provide a base station apparatus, mobile station apparatus, communication system, channel estimating method, transmitting antenna detecting method and program for allowing PVS to be applied as an SCH transmitting diversity method and improving neighboring cell search performance by preventing side lobes.

Further, it is also an object of the present invention to provide a base station apparatus, mobile station apparatus, communication system, channel estimating method, transmitting antenna detecting method and program for specifying the number of transmitting antennas in the first step of cell search and receiving SCHs regardless of the number of transmitting antennas of Node B.

### Means for Solving the Problem

The base station apparatus according to the present invention that performs multicarrier communication, employs a configuration which includes: a synchronization channel sequence generating section that generates synchronization channel sequences; a subcarrier group generating section that generates a subcarrier group formed with a plurality of subcarriers, for a multicarrier signal, and that associates a number of transmitting antennas with a periodicity and/or a number of subcarriers of the subcarrier group, makes synchronization channel sequences from the synchronization channel sequence generating section a subcarrier group, based on the periodicity and/or the number of subcarriers associated with the number of transmitting antennas and outputs the subcarrier group; and a precoding weight matrix generating section that sets a plurality of synchronization channel sequences uniquely associated with precoding weight matrices that vary between subcarrier groups, and generates the precoding weight matrices associated with the plurality of set synchronization channel sequences.

The mobile station apparatus according to the present invention employs a configuration which includes: a receiving section that receives a multicarrier signal transmitted from a base station apparatus; a detecting section that detects synchronization channel sequences from the received multicarrier signal; a precoding weight matrix specifying section that specifies precoding weight matrices associated uniquely with the synchronization channel sequences, from the detected synchronization channel sequences; an auto-correlation section that finds auto-correlation characteristics of the detected synchronization channel sequences; and a transmitting antenna number specifying section that specifies a number of transmitting antennas associated with a periodicity and/or a number of subcarriers assigned to a subcarrier group formed with a plurality of subcarriers, based on a periodicity of the auto-correlation characteristics.

The communication system according to the present invention that performs multicarrier communication, employs a configuration in which: a base station apparatus has a synchronization channel sequence generating section that generates synchronization channel sequences; a subcarrier group generating section that generates a sub carrier group formed with a plurality of subcarriers, for a multicarrier signal, and that associates a number of transmitting antennas with a periodicity and/or a number of subcarriers of the subcarrier group, makes synchronization channel sequences from the synchronization channel sequence generating section a subcarrier group, based on the periodicity and/or the number of subcarriers associated with the number of transmitting antennas and outputs the subcarrier group; and a precoding weight matrix generating section that sets a plurality of synchronization channel sequences uniquely associated with preceding weight matrices that vary between subcarrier groups, and generates the precoding weight matrices associated with the plurality of set synchronization channel sequences; and a mobile station apparatus has: a receiving section that receives the multicarrier signal transmitted from the base station apparatus; a detecting section that detects the synchronization channel sequences from the received multicarrier signal; a precoding weight matrix specifying section that specifies the precoding weight matrices associated uniquely with the synchronization channel sequences, from the detected synchronization channel sequences; an auto-correlation section that finds auto-correlation characteristics of the detected synchronization channel sequences; and a transmitting antenna number specifying section that specifies the number of transmitting antennas associated with the periodicity and/or the number of subcarriers assigned to the subcarrier group, based on a periodicity of the auto-correlation characteristics.

The channel estimating method according to the present invention includes: generating a subcarrier group formed with a plurality of subcarriers, for a multicarrier signal; setting a plurality of synchronization channel sequences uniquely associated with precoding weight matrices that vary between subearrier groups, and generating the precoding weight matrices associated with the plurality of set synchronization channel sequences; specifying the precoding weight matrices uniquely associated with the synchronization channel sequences; and estimating a channel based on the specified precoding weight matrices.

The transmitting antenna detecting method according to the present invention includes: generating synchronization channel sequences; associating a number of transmitting antennas with a periodicity and/or a number of subcarriers of a subcarrier group formed with a plurality of subcarriers, making the generated synchronization channel sequences a subcarrier group based on the periodicity and/or the number of subcarriers associated with the number of transmitting antennas and outputting the subcarrier group; finding auto-correlation characteristics of the synchronization channel sequences; and specifying the number of transmitting antennas associated with the periodicity and/or the number of subcarriers assigned to the subcarrier group, based on a periodicity of the auto-correlation characteristics.

Further, from another perspective, the present invention provides a program for making the computer execute each step of the above channel estimating method and transmitting antenna detecting method.

### Advantageous Effects of Invention

According to the present invention, it is possible to apply PVS as an SCH transmission diversity method by specifying PSC sequences and identifying precoding weight matrices, and improve neighboring cell search performance by preventing side lobes.

Further, it is possible to specify the number of transmitting antennas in the first step of cell search by associating the number of transmitting antennas with the number of subcarriers assigned to a subcarrier group, and receive SCHs, regardless of the number of transmitting antennas of Node B.

### BRIEF DESCRIPTION OF DRAWINGS

FIG. 1 shows a frame configuration in conventional 3 step cell search;

FIG. 2 shows an example of a frame configuration of a signal transmitted from a conventional multicarrier transmitting apparatus;

FIG. 3 shows cell search performance in case where conventional SCH transmission diversity is used;

FIG. 4 illustrates SCH transmission using PVS according to [Explanation of the principle of the present invention];

FIG. 5 shows the state of reception in case where PVS is used for SCHs according to [Explanation of the principle of the present invention];

FIG. 6 shows the state in case where PVS and FSTD are combined according to [Explanation of the principle of the present invention];

FIG. 7 shows an example of estimation of channels from transmitting antennas in case where PVS and FSTD are combined according to [Explanation of the principle of the present invention];

FIG. 8 illustrates auto-correlation detection using a P-SCH according to [Explanation of the principle of the present invention];

FIG. 9 illustrates the principle of the present invention;

FIG. 10 illustrates the principle of the present invention;

FIG. 11 shows the state of reception of SCHs by a P-BCH channel estimating method according to [Explanation of the principle of the present invention];

FIG. 12 shows a table listing correspondences between PSC sequences and precoding weight matrices according to [Explanation of the principle of the present invention];

FIG. 13A illustrates an association of the number of subcarriers of subcarrier groups with the number of transmitting antennas according to [Explanation of the principle of the present invention] (in case of one transmitting antenna);

FIG. 13B illustrates an association of the number of subcarriers of subcarrier groups with the number of transmitting antennas according to [Explanation of the principle of the present invention] (in case of two transmitting antennas);

FIG. 13C illustrates an association of the number of subcarriers of subcarrier groups with the number of transmitting antennas according to [Explanation of the principle of the present invention] (in case of four transmitting antennas);

FIG. 13D illustrates an association of PSC sequences with weight matrices according to [Explanation of the principle of the present invention];

FIG. 14A illustrates a transmitting antenna deciding method according to [Explanation of the principle of the present invention] (in case of one transmitting antenna);

FIG. 14B illustrates a transmitting antenna deciding method according to [Explanation of the principle of the present invention] (in case of two transmitting antennas);

FIG. 14C illustrates a transmitting antenna deciding method according to [Explanation of the principle of the present invention] (in case of four transmitting antennas);

FIG. 15 shows auto-correlation characteristics of a received SCH signal of FIG. 14;

FIG. 16 illustrates the cell search steps according to [Explanation of the principle of the present invention];

FIG. 17 shows an example of a frame configuration of a signal transmitted from a transmitter according to [Explanation of the principle of the present invention];

FIG. 18A illustrates an association of the number of transmitting antennas with the number of PSC sequences used in a P-SCH according to [Explanation of the principle of the present invention] (in case of two transmitting antennas);

FIG. 18B illustrates an association of the number of transmitting antennas with the number of PSC sequences used in a P-SCH according to [Explanation of the principle of the present invention] (in case of four transmitting antennas);

FIG. 19 shows a radio frame configuration assumed in Embodiment 1 of the present invention;

FIG. 20 is a block diagram showing a configuration of a base station apparatus according to Embodiment 1 of the present invention;

FIG. 21A illustrates how subcarrier groups are generated in a subcarrier group generating section of the base station apparatus according to Embodiment 1 of the present invention (in case of one transmitting antenna);

FIG. 21B illustrates how subcarrier groups are generated in a subcarrier group generating section of the base station apparatus according to Embodiment 1 of the present invention (in case of two transmitting antennas);

FIG. 21C illustrates how subcarrier groups are generated in a subcarrier group generating section of the base station apparatus according to Embodiment 1 of the present invention (in case of four transmitting antennas);

FIG. 22 shows a table listing correspondences between PSC sequences and precoding weight matrices in a precoding weight matrix generating section of the base station apparatus according to Embodiment 1 of the present invention;

FIG. 23 is a block diagram showing a configuration of a mobile station apparatus according to Embodiment 1 of the present invention;

FIG. 24 is a block diagram showing a detailed configuration of an SCH reception processing section of the mobile station apparatus according to Embodiment 1 of the present invention;

FIG. 25A illustrates the state of a received channel of a P-SCH per transmitting antenna of the mobile station apparatus according to Embodiment 1 of the present invention (in case of one transmitting antenna);

FIG. 25B illustrates the state of received channels of P-SCHs per transmitting antenna of the mobile station apparatus according to Embodiment 1 of the present invention (in case of two transmitting antennas);

FIG. 25C illustrates the state of received channels of P-SCHs per transmitting antenna of the mobile station apparatus according to Embodiment 1 of the present invention (in case of four transmitting antennas);

FIG. 26 shows auto-correlation characteristics of a received channel of the P-SCH of FIG. 25;

FIG. 27 is a block diagram showing a detailed configuration of an RS reception processing section of the mobile station apparatus according to Embodiment 1 of the present invention;

FIG. 28 is a block diagram showing a detailed configuration of a P-BCH reception processing section of the mobile station apparatus according to Embodiment 1 of the present invention;

FIG. 29 is a flowchart showing the cell search procedure according to Embodiment 1 of the present invention;

FIG. 30 is a block diagram showing a configuration of the base station apparatus according to Embodiment 2 of the present invention;

FIG. 31A illustrates how PSC sequences are mapped per transmitting antenna of a subcarrier mapping section of the base station apparatus according to Embodiment 2 of the present invention (in case of one transmitting antenna);

FIG. 31B illustrates how PSC sequences are mapped per transmitting antenna of a subcarrier mapping section of the base station apparatus according to Embodiment 2 of the present invention (in case of two transmitting antennas);

FIG. 31C illustrates how PSC sequences are mapped per transmitting antenna of a subcarrier mapping section of the base station apparatus according to Embodiment 2 of the present invention (in case of four transmitting antennas);

FIG. 32 shows a mapping table of PSC sequences and precoding weight matrices of the base station apparatus according to Embodiment 2 of the present invention;

FIG. 33 shows a mapping table of PSC sequences and precoding weight matrices of the base station apparatus according to Embodiment 2 of the present invention;

FIG. 34 is a block diagram showing a detailed configuration of an SCH reception processing section of the mobile station apparatus according to Embodiment 2 of the present invention; and

FIG. 35 shows a table listing correspondences between the number of PSC sequences and the number of transmitting antennas of the mobile station apparatus according to Embodiment 2 of the present invention.

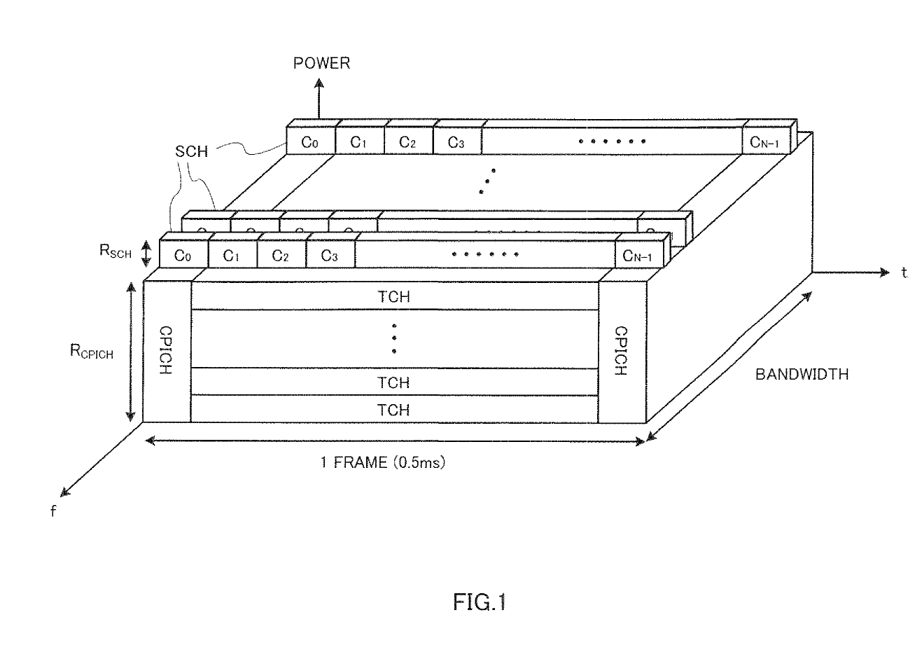

### BEST MODE FOR CARRYING OUT THE INVENTION

Hereinafter, embodiments of the present invention will be explained in detail with reference to the accompanying drawings.

### Explanation of the Principle of the Present Invention

The basic principle of the present invention will be explained.

First, PVS will be described, and then the reason why PVS is not applicable to SCH transmission diversity methods will be explained.

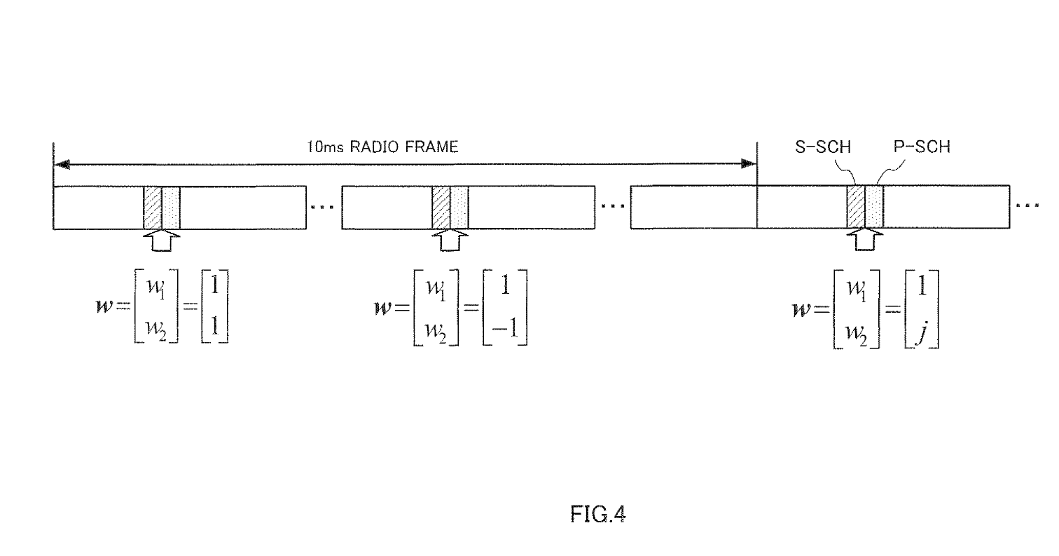

FIG. 4 illustrates SCH transmission by means of PVS. In FIG. 4, the hatched portions represent S-SCHs, and the shaded portions represent P-SCHs. FIG. 4 assumes transmission using two antennas, and w₁ and w₂ represent precoding weights applied to SCHs of transmitting antennas 1 and 2 (Tx1 and Tx2).

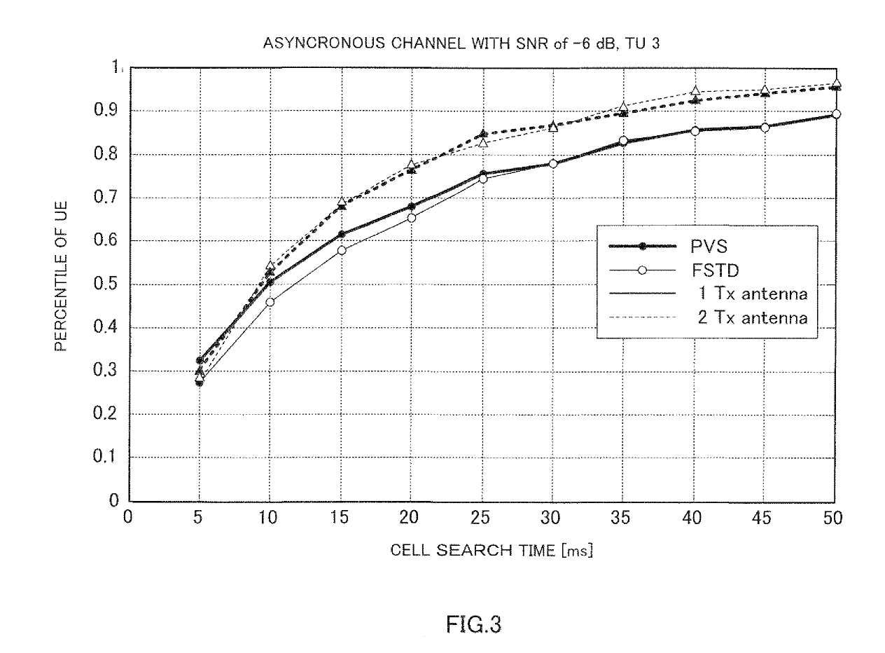

PVS provides beam forming gain by multiplying SCH symbols with precoding weights, and provides diversity gain by changing precoding weights on a per SCH symbol basis. As shown in above FIG. 3, in case where PVS is used for SCHs, performance upon initial cell search (upon low SINR) and performance upon neighboring cell search are good.

Considering SCHs alone, PVS is the optimal transmission diversity method. However, when the relationship between PVS and P-BCHs received after synchronization is taken into account, PVS has the following drawbacks.

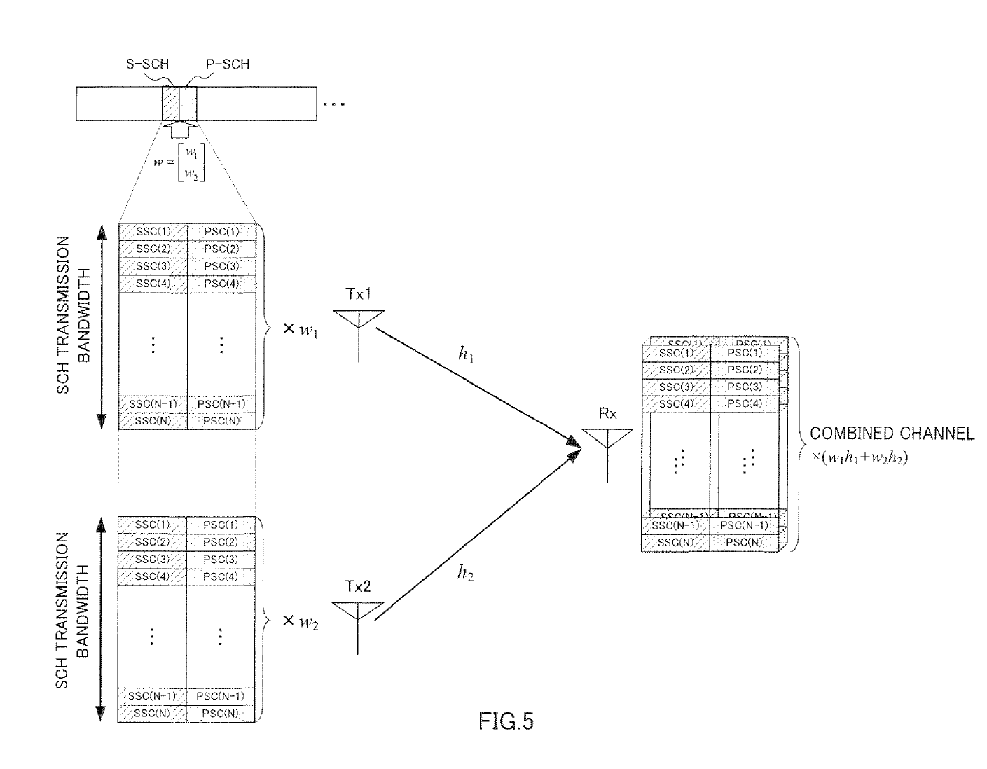

FIG. 5 shows the state of reception in case where PVS is used for SCHs. Similar to FIG. 4, in FIG. 5, the hatched portions represent S-SCHs and the shaded portions represent P-SCHs, and w₁ and w₂ represent precoding weights applied to SCHs of transmitting antennas 1 and 2 (Tx1 and Tx2). Further, a PSC (Primary Synchronization Code) and an SSC (Secondary Synchronization Code) represent code sequences used for a P-SCH and an S-SCH, respectively, and N represents the sequence length.

As shown in the left side of FIG. 5 (i.e. transmitting side), with PVS, PSCs and SSCs are mapped on subcarriers.

On the receiving side shown in the right side of FIG. 5, SCHs multiplied with weights in transmitting antennas are combined after having passed through channels h₁ and h₂. PVS provides beam forming gain by combining channels. Therefore, only channels w₁h₁+w₂h₂ that are combined can only be estimated for received SCHs, and channels h₁ and h₂ from the transmitting antennas cannot be estimated. This leads to limiting transmission diversity methods used for P-BCHs. With LTE, although SFBC (Space Frequency Block Coding) of good receiving performance is used for a P-BCH transmission diversity method, SFBC needs to estimate channels from the transmitting antennas, and therefore, in case where SFBC is applied to P-BCHs, PVS is not applicable to SCHs.

In other words, if channels from transmitting antennas can be estimated, it is possible to use SFBC of good performance for P-BCHs. It has been determined that, with LTE, SFBC is used for P-BCHs.

Next, the method of combining PVS and FSTD will be explained.

A case has been explained where, if PVS is applied to SCH transmission diversity, it is not possible to estimate channels from transmitting antennas. As a method of solving this, a method of combining PVS and FSTD is possible.

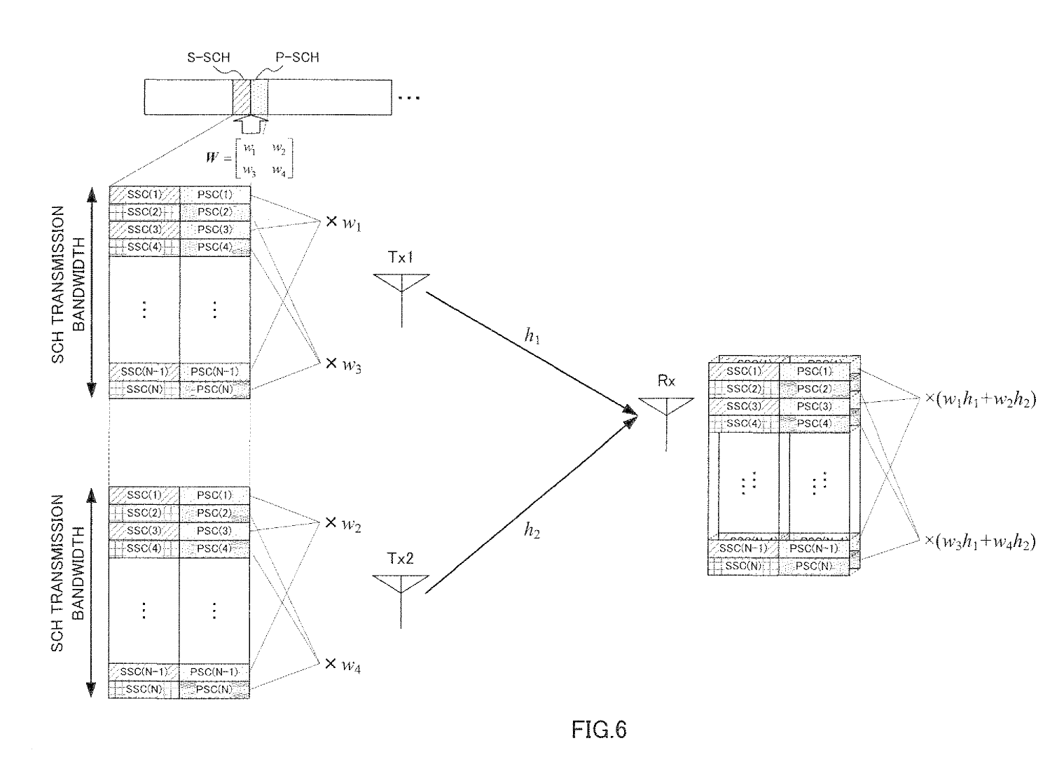

FIG. 6 shows the state where PVS and FSTD are combined. In this figure, W represents a precoding weight matrix.

On the transmitting side shown in the left side of FIG. 6, different precoding weight vectors are assigned to even-numbered subcarriers (also referred to as “SCs (Sub Carriers)”) and odd-numbered subcarriers (SCs) of SCHs. On the receiving side shown in the right side of FIG. 6, channels are estimated by multiplying the even-numbered subcarriers and the odd-numbered subcarriers with different precoding weights such that orthogonality is established between transmitting antennas and between subcarriers. This method makes it possible to estimate channels from transmitting antennas as follows. When a received SCH signal is assumed as “y,” y is represented by following equation 1. Note that the influence of noise is not taken into account. Although equation 1 has been expressed as to an SSC, the same equation holds for the PSC.

$$\begin{matrix}( Equation 1 ) & \\ \begin{matrix}[ \begin{matrix}y ( 2 n - 1 ) \\ y ( 2 n )\end{matrix} ] = [ \begin{matrix}{w}_{1} {h}_{1} + {w}_{2} {h}_{2} \\ {w}_{3} {h}_{3} + {w}_{4} {h}_{4}\end{matrix} ] [ \begin{matrix}SSC ( 2 n - 1 ) \\ SSC ( 2 n )\end{matrix} ] \\ = [ \begin{matrix}{w}_{1} & {w}_{2} \\ {w}_{3} & {w}_{4}\end{matrix} ] [ \begin{matrix}{h}_{1} \\ {h}_{2}\end{matrix} ] [ \begin{matrix}SSC ( 2 n - 1 ) \\ SC ( 2 n )\end{matrix} ]\end{matrix} & [ 1 ]\end{matrix}$$

As shown in equation 1, SSCs are sequences that are known on the receiving side, and therefore, as shown in equation 2, it is possible to estimate channels h₁ and h₂ from transmitting antennas by multiplying the received SCH signal divided by SSCs, with inverse matrices W⁻¹ of precoding weight matrices W.

$$\begin{matrix}( Equation 2 ) & \\ [ \begin{matrix}{h}_{1} \\ {h}_{2}\end{matrix} ] = {[ \begin{matrix}{w}_{1} & {w}_{2} \\ {w}_{3} & {w}_{4}\end{matrix} ]}^{- 1} [ \begin{matrix}y ( 2 n - 1 ) / SSC ( 2 n - 1 ) \\ y ( 2 n ) / SSC ( 2 n )\end{matrix} ] & [ 2 ]\end{matrix}$$

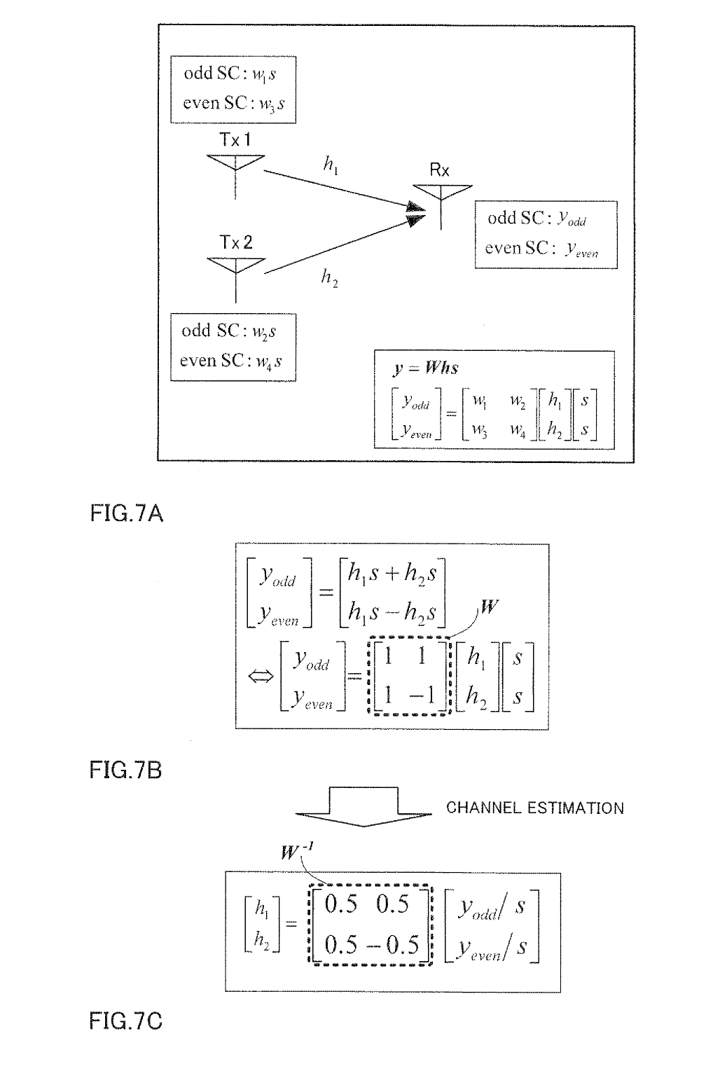

FIG. 7 shows an example of estimation of channels from transmitting antennas in case where PVS and FSTD are combined. A case where transmitting antennas 1 and 2 (Tx1 and Tx2) are provided (that is, the case of two transmitting antennas) is shown.

In FIGS. 7A and B, channels are estimated as shown in FIG. 7C by multiplying the odd-numbered subcarriers (SCs) and the even-numbered subcarriers (SCs) with different precoding weights such that orthogonality is established between transmitting antennas and between subcarriers (SCs).

PVS applies weights, which are referred to as “precoding weights,” to SCH symbols, and changes precoding weights on a per SCH symbol basis. As shown in FIG. 7B, if, for example, two SCH symbols are arranged in a radio frame of, for example, 10 milliseconds, weights are changed on a per SCH symbol basis by multiplying a precoding weight (1,1) with a certain SCH symbol and then multiplying a precoding weight (1, −1) with the next SCH symbol.

The above method of combining PVS and FSTD has the following problem.

As shown in FIG. 4, precoding weights that vary between SCHs are multiplied with each SCH. On the receiving side, UE does not know which precoding weights are multiplied by Node B, and therefore it is not possible to find the inverse matrices of the precoding weight matrices in equation 2 and estimate channels h₁ and h₂ from transmitting antennas. That is, channels are estimated by multiplying even-numbered SCs and odd-numbered SCs with different precoding weights such that orthogonality is established between transmitting antennas and between SCs. Therefore, UE needs to know weight matrices W formed with the dimension of the number of transmitting antennas and SCs. If (1), for example, precoding weights multiplied by Node B are reported so that UE knows weight matrices W formed with the dimension of the number of transmitting antennas and SCs, the amount of control information increases in DL (Downlink). Further, if (2) the precoding weights are limited to one kind, new problems arise that a time diversity effect decreases and inter-cell interference increases.

Furthermore, there is the following problem in addition to the above problems.

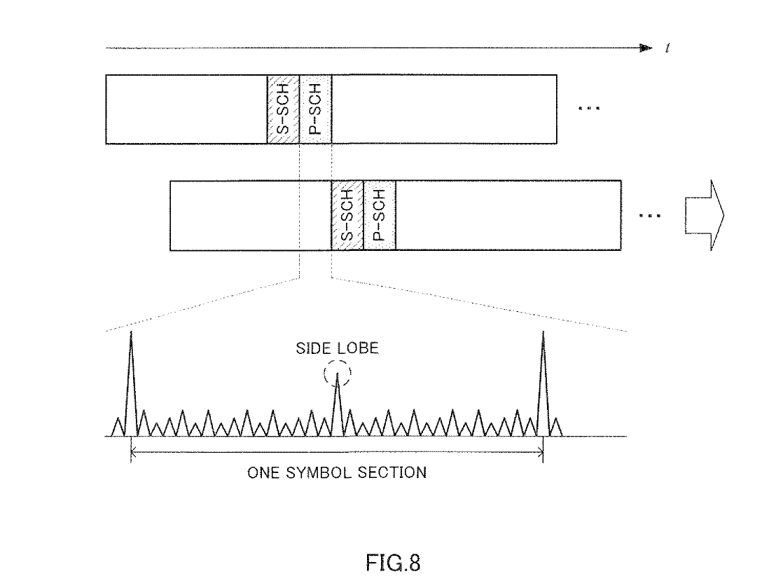

FIG. 8 illustrates auto-correlation detection using a P-SCH.

As shown in FIG. 8, in case where weights are multiplied alternately with the odd-numbered subcarrier and even-numbered subcarrier to detect the timing using a P-SCH, when correlation is determined between a P-SCH received signal and P-SCH replicas in the time domain, a side lobe is produced in correlation characteristics and neighboring cell search performance in particular deteriorates.

To sum up the problems of the method of combining PVS and FSTD, there are the following problems (1) and (2).

(1) Although a plurality of precoding weight matrices W are provided to provide time diversity and to alleviate inter-cell interference, UE cannot specify precoding weight matrices W and therefore cannot estimate a channel for demodulation of a P-BCH subjected to SFBC transmission.

(2) If correlation is found between a P-SCH received signal and P-SCH replicas in the time domain, a side lobe is produced in correlation characteristics and neighboring cell search performance in particular deteriorates.

As described above, with the method of combining PVS and FSTD, other new problems arise, and therefore it is still difficult to apply PVS as an SCH transmission diversity method. The current state is that SCH transmission diversity methods to which PVS is applicable are limited.

### Applying PVS to SCH Transmission Diversity

The inventors of the present invention focus on that it is possible to specify PSC sequences by associating a plurality of PSC sequences with precoding weight matrices. To be more specific, to apply PVS to the frequency domain of SCHs, the inventors have arrived at identifying precoding weight matrices by providing subcarrier groups formed with a plurality of subcarriers, applying different precoding weights to neighboring subcarrier groups, associating a plurality of PSC sequences with precoding weight matrices and specifying a PSC sequence.

A PSC sequence is specified in the first step of cell search and thereby the precoding weight matrices of PVS are also specified, so that, while SCHs provide gain thanks to PVS, it is possible to estimate channels from transmitting antennas. Further, by applying varying precoding weights between subcarrier groups, it is possible to prevent side lobes from being produced when auto-correlation is detected using a P-SCH.

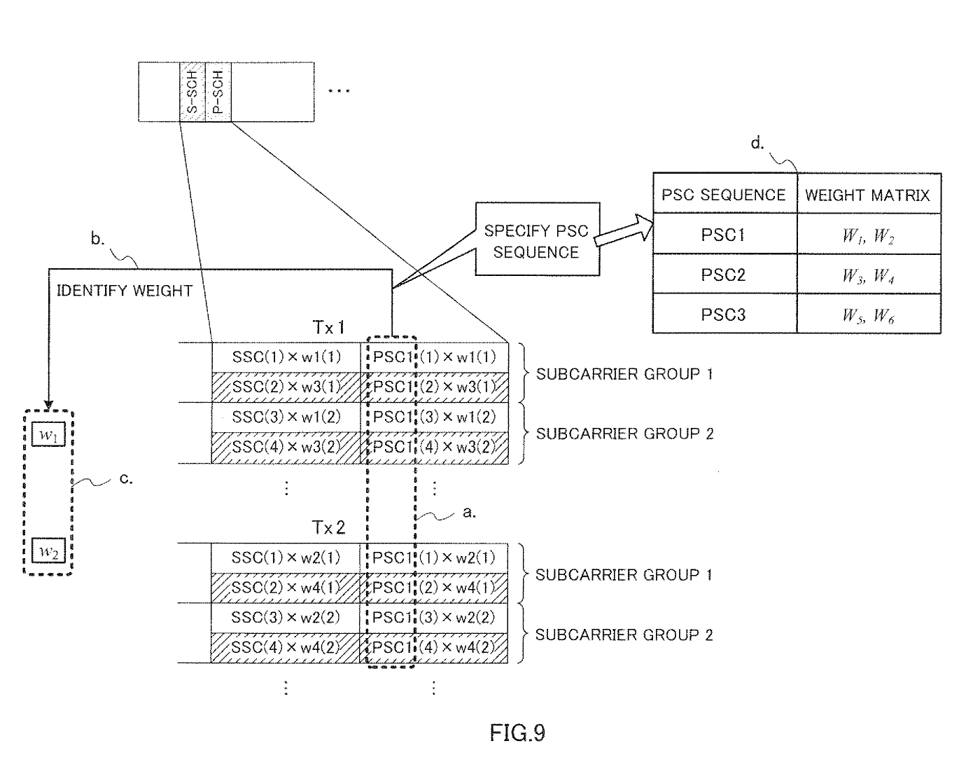

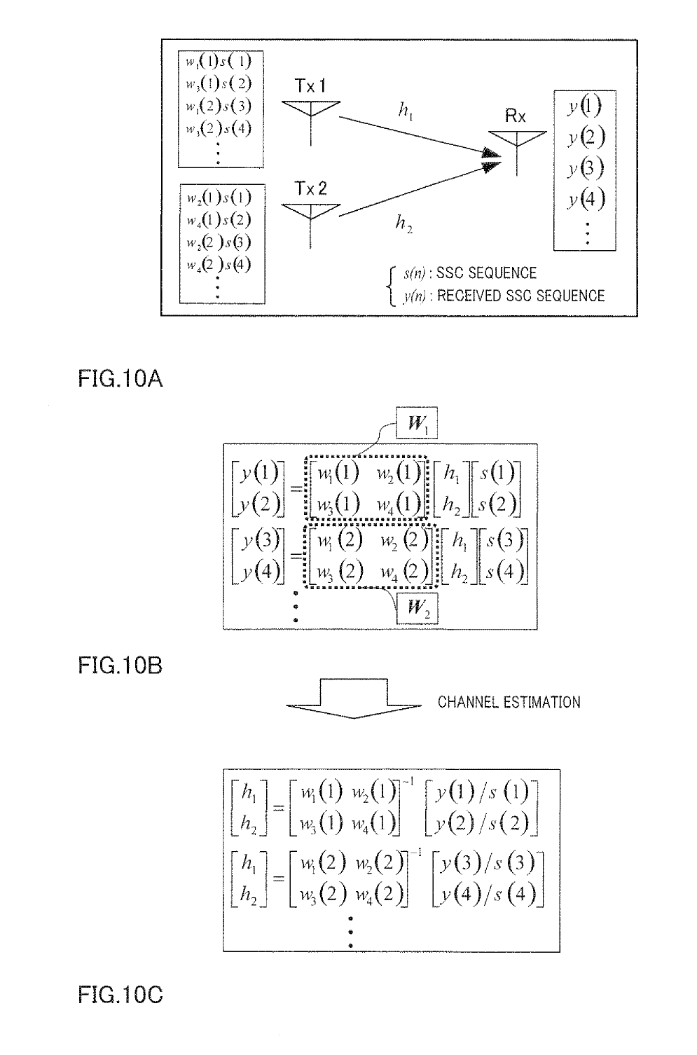

FIG. 9 and FIG. 10 explain the basic concept of the present invention. A case will be adopted as an example where transmitting antennas 1 and 2 (Tx1 and Tx2) are provided.

In FIG. 9, to apply PVS to the frequency domain of SCHs, different precoding weights are applied to subcarrier groups (subcarrier group 1 and subcarrier group 2) formed with a plurality of subcarriers. To be more specific, a plurality of PSC sequences and precoding weight matrices are specified by assuming that P-PSC shown in FIG. 9 as a plurality of PSC sequences PSC1, PSC2 and PSC3 shown in FIG. 9 d., and associating a plurality of PSC sequences PSC1, PSC2 and PSC3 with pairs of precoding weight matrices W₁ & W₂, . . . , and W₅ & W₆ on a one-by-one basis. In FIG. 9, PSC sequence PSC1 is associated with precoding weight matrices W₁ and W₂, PSC sequence PSC2 is associated with precoding weight matrices W₃ and W₄, and PSC sequence PSC3 is associated with precoding weight matrices W₅ and W₆. Accordingly, by specifying PSC sequences PSC1, PSC2 and PSC3, it is possible to specify pairs of precoding weight matrices W₁ & W₂, . . . , and W₅ & W₆ of PVS or vice versa. The reason why a plurality of PSC sequences PSC1, PSC2 and PSC3 are each associated with two kinds of precoding weight matrices (W₁ & W₂, W₃ & W₄, and W₅ & W₆), is to prevent side lobes from being produced by switching and using two kinds of precoding weights on a per subcarrier group basis, randomizing the weights assigned to subcarriers and reducing the regularity. If production of side lobes needs not to be taken into account or can be neglected, only one kind of a precoding weight matrix needs to be associated with a plurality of PSC1, PSC2 and PSC3.

As shown in FIG. 9 a., subcarrier groups (subcarrier group 1 and subcarrier group 2) formed with a plurality of subcarriers are provided, and different precoding weights W₁ and W₂ are applied to neighboring subcarrier groups. As shown in FIG. 9 b., by specifying PSC sequences PSC1, PSC2 and PSC3, it is possible to identify precoding weights W₁ and W₂ of PVS as shown in FIG. 9c.

Originally, processing of specifying P-PSC sequences is performed without fail in cell search. In this cell search processing, it is possible to specify precoding weight matrices and execute channel estimation.

In FIGS. 10A and B, UE estimates channels from transmitting antennas as shown in FIG. 10C, by dividing received SCH signals by PSC/SSC sequences as shown in above equation 2 and multiplying the division result with the inverse matrices of the precoding weight matrices that have been identified.

The above described basic concept of the present invention will be generalized and explained in detail.

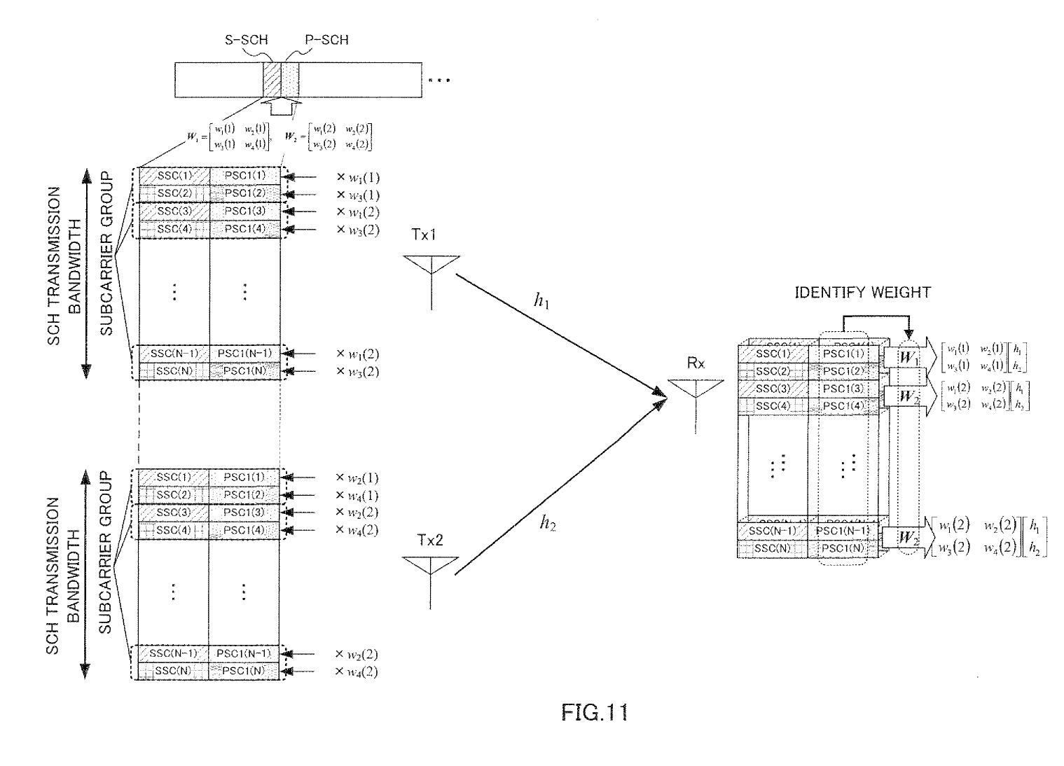

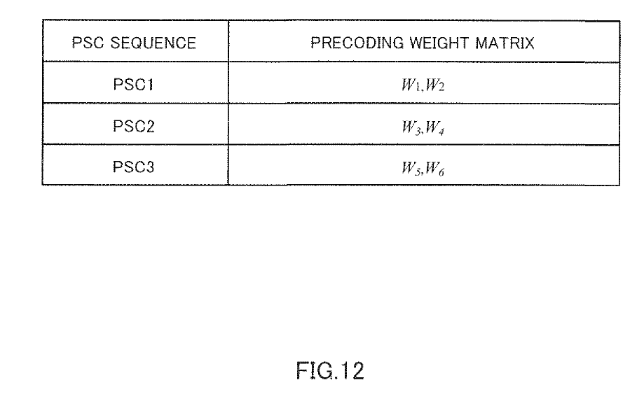

FIG. 11 shows the state of reception of SCHs according to the P-BCH channel estimating method. FIG. 12 shows the table showing a table listing correspondences between PSC sequences and precoding weight matrices.

In the SCH transmission bandwidth, a subcarrier group formed with a plurality of subcarriers is provided. In FIG. 11, one subcarrier group is formed with two subcarriers. For example, as shown in the left side of FIG. 11 (i.e. transmitting side), pairs of SSC (1) and SSC (2), SSC (3) and SSC (4), and SSC (N−1) and SSC (N) each form subcarrier groups.

Then, different precoding weight matrices (i.e. W₁ and W₂ in FIG. 11) are used between neighboring subcarrier groups. At this time, as shown in the table of FIG. 12, PSC sequences and sets of precoding weight matrices applied to subcarrier groups are associated on a one-by-one basis.

PSC sequences are identified in the first step of cell search, and therefore precoding weight matrices applied to subcarrier groups are specified. In FIG. 11, PSC1 is used as the PSC sequence, so that it is possible to identify that precoding weight matrices W₁ and W₂ are applied. Consequently, as shown in the right side of FIG. 11 (i.e. the receiving side), UE can estimate channels from transmitting antennas by dividing received SCH signals by PSC/SSC sequences as shown in above equation 2 and multiplying the division results with the inverse matrices of the precoding weight matrices that have been identified. Here, channel estimation values acquired on a per subcarrier basis may be averaged.

In this way, according to the P-BCH channel estimating method of the present invention, weights that establish orthogonality between transmitting antennas and between subcarriers are applied to an SCH as weights of PVS, and weights are switched on a per subcarrier group basis. Further, by associating PSC sequences with weight sequences and specifying PSC sequences, precoding weight matrices are identified.

By this means, weight matrices can be specified from PSC sequences, so that, while SCHs provide gain thanks to PVS, it is possible to estimate P-BCH channels that assume an S-SCH as an RS. Further, by applying weights to subcarrier groups, it is possible to avoid side lobes in correlation characteristics of P-SCH replicas and improve neighboring cell search performance.

As described above, the P-BCH channel estimating method of the present invention allows PVS to be applied to SCH transmission diversity for the first time.

Further, by adopting the following variation, it is possible to provide a more unique advantage.

Depending on the number of transmitting antennas of the base station apparatus, the dimension of precoding weight matrices changes. Therefore, it is necessary to specify precoding weight matrices and learn the number of transmitting antennas. If the number of transmitting antennas is not learned, it is not possible to determine precoding weight matrices uniquely. The inventors of the present invention have arrived at the following two methods as the method of specifying or notifying the number of transmitting antennas.

### Specifying the Number of Transmitting Antennas (1)

The present invention specifies the number of transmitting antennas by associating the number of transmitting antennas with the number of sub carriers assigned to subcarrier groups and detecting the periodicity of auto-correlation characteristics of a received SCH signal.

1. Associating the number of transmitting antennas with the number of subcarriers of subcarrier groups

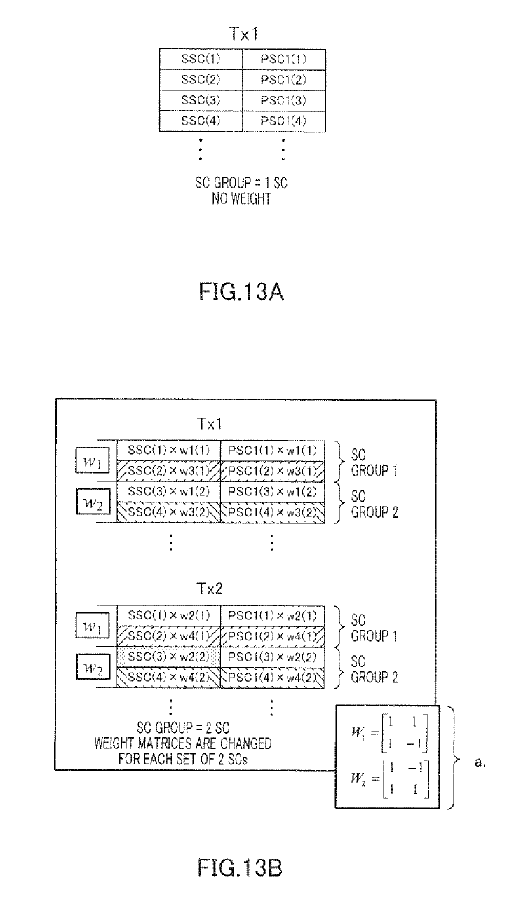

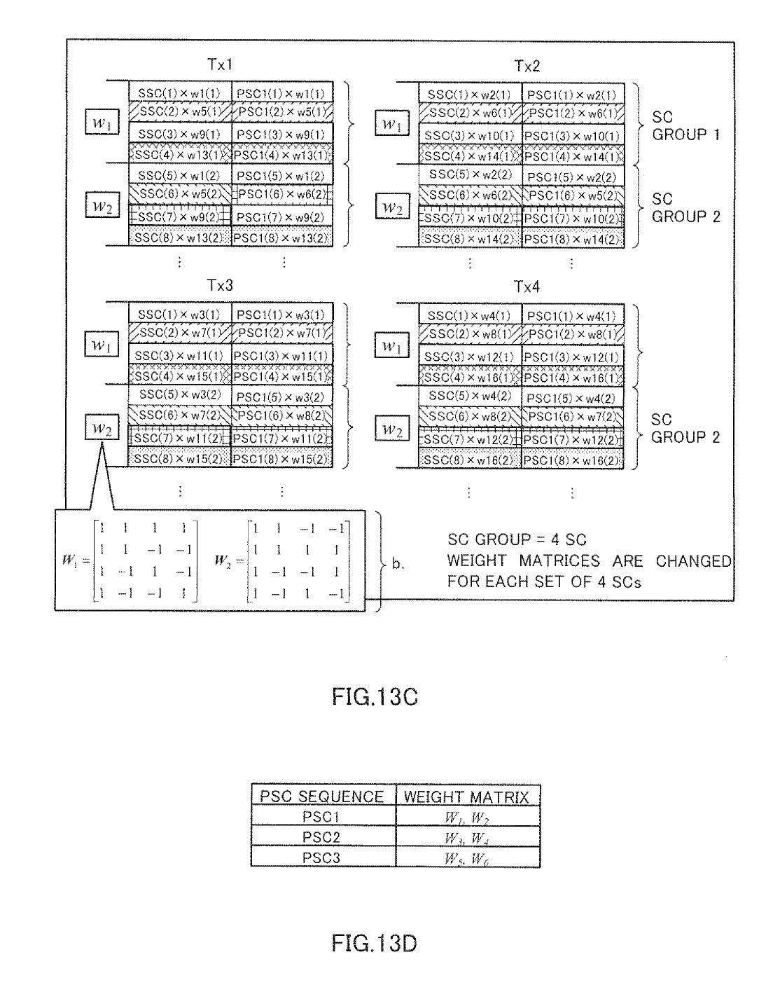

FIG. 13 explains the basic concept of associating the number of transmitting antennas with the number of subcarriers of subcarrier groups. FIG. 13A shows a case of one transmitting antenna (Tx1), FIG. 13B shows the case of two transmitting antennas (Tx1 and Tx2) and FIG. 13C shows the case of four transmitting antennas (Tx1 to Tx4).

In FIG. 13A, in case of one transmitting antenna (Tx1), a subcarrier group is formed with one subcarrier (SC), and is not multiplexed with a precoding weight.

In FIG. 13B, in case of two transmitting antennas (Tx1 and Tx2), similar to the case of above FIG. 9, different precoding weight matrices W₁ and W₂ are applied to subcarrier groups formed with a plurality of subcarriers (see FIG. 13B a.). Further, as shown in FIG. 13D, PSC sequences are specified by associating a plurality of PSC sequences PSC1, PSC2 and PSC3 with pairs of precoding weight matrices W₁ & W₂, . . . , and W₅ & W₆. In case of above FIG. 9, different precoding weights W₁ and W₂ are applied to neighboring subcarrier groups. In case of FIG. 13B, not only different precoding weights W₁ and W₂ are applied to neighboring subcarrier groups, but also the number of subcarriers of two subcarrier groups is associated with the number of transmitting antennas (Tx1 and Tx2) to change weight matrices for each set of two subcarriers (SCs). The association of the number of transmitting antennas with the number of subcarriers assigned to subcarrier groups is more clear in case of four transmitting antennas (Tx1 to Tx4).

In FIG. 13C, in case of four transmitting antennas (Tx1 to Tx4), a subcarrier group is formed with four subcarrier (SCs), different precoding weights W₁ and W₂ are applied to four subcarrier groups (see FIG. 13C b.), and the number of subcarriers “4” of four subcarrier groups are associated with the number of transmitting antennas (Tx1 to Tx4) to change the weight matrices for each set of four subcarrier (SCs) groups.

As described above, the base station apparatus associates the number of transmitting antennas with a group of subcarriers to which weights are applied. For example, in case of one transmitting antenna (Tx1), there is no precoding weight. In case of two transmitting antennas (Tx1 and Tx2), precoding weights are multiplied with subcarrier groups each formed with two subcarriers, and, in case of four transmitting antennas (Tx1 to Tx4), precoding weights are multiplied with subcarrier groups each formed with four subcarriers. That is, by associating the number of subcarriers of subcarrier groups with the number of transmitting antennas, different precoding matrices are applied according to the number of transmitting antennas.

Based on the association of the number of subcarriers of subcarrier groups with the number of transmitting antennas performed in the base station apparatus, a receiving apparatus specifies the number of transmitting antennas according to the following transmitting antenna detecting method.

2. Transmitting Antenna Detecting Method.

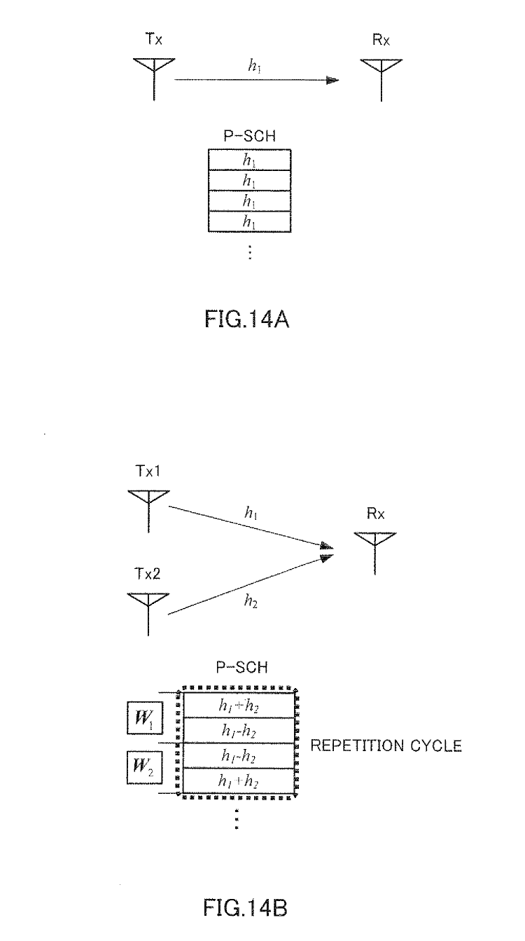

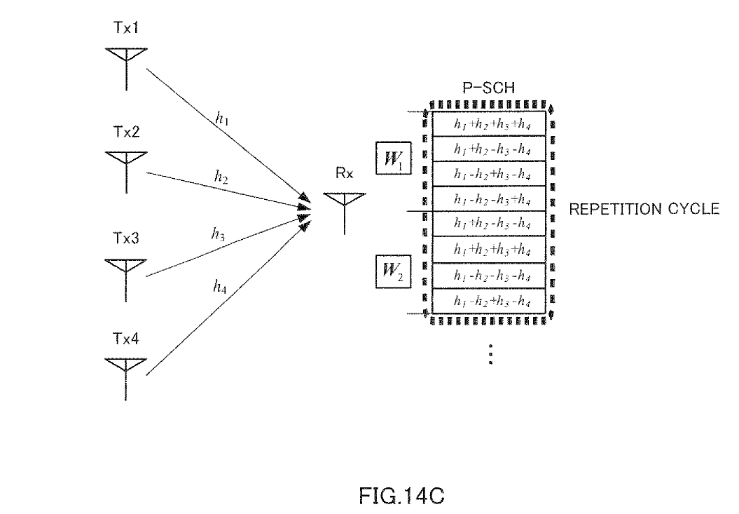

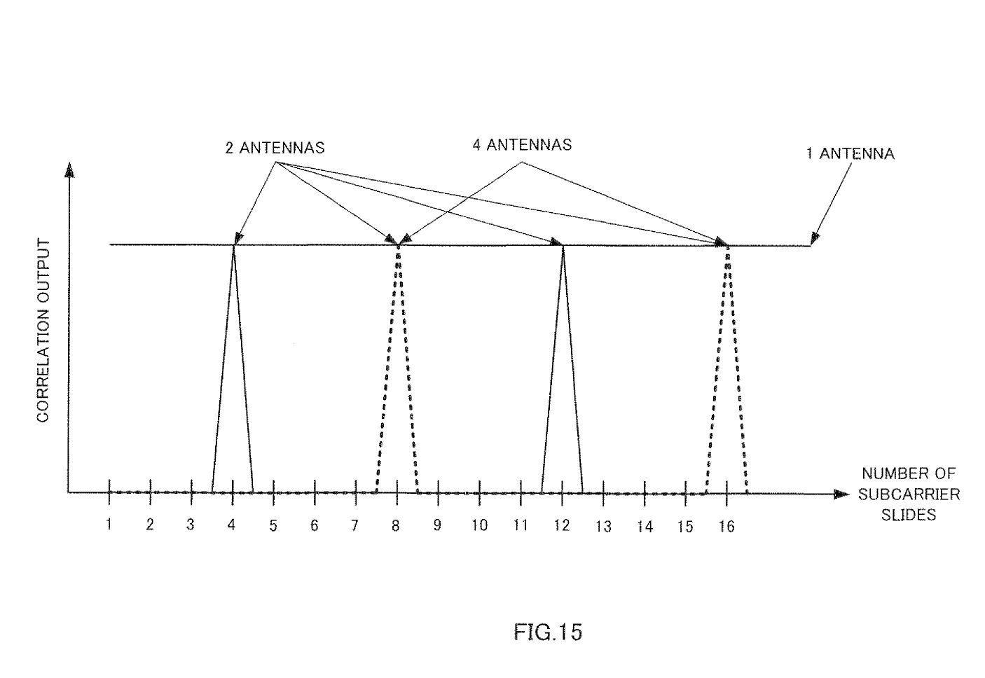

FIG. 14 illustrates the basic concept of the transmitting antenna detecting method. FIG. 14A shows the case of one transmitting antenna (Tx1), FIG. 14B shows the case of two transmitting antennas (Tx1 and Tx2), and FIG. 14C shows the ease of four transmitting antennas (Tx1 to Tx4). FIG. 15 shows auto-correlation characteristics of received SCH signals of FIGS. 14A to C.

(1) Specifying PSC Sequences

As described above, different precoding weights W₁ and W₂ are applied to subcarrier groups each formed with a plurality of subcarrier. The PSC sequences are associated with precoding weight matrices W₁ and W₂, so that UE can specify PSC sequences.

(2) Dividing Received P-SCH by PSC Sequence

UE estimates channels from transmitting antennas by dividing received SCH signals by PSC/SSC sequences as shown in above equation 2 and multiplying the division results with the inverse matrices of the identified precoding weight matrices.

(3) Detecting Correlation by Offsetting SCs in the Frequency Domain

The present invention associates the number of transmitting antennas with the number of subcarriers assigned to subcarrier groups. Consequently, as shown by the frame indicated by the broken line of FIGS. 14B and C, a received SCH signal divided by a PSC sequence has a repetition cycle. UE detects the correlation of this repetition cycle by offsetting subcarriers (SCs) in the frequency domain.

(4) Detecting Transmitting Antennas Based on the Detection Result of Correlation

As shown in FIG. 15, UE can detect peaks matching the antennas by detecting the auto-correlation of a received SCH signal by offsetting SCs in the frequency domain, and adding and averaging auto-correlation results over a plurality of frames.

In case of one antenna, a peak has 1 SC cycle (that is, a peak is detected at all times). In case of two antennas, peak characteristics show that the apex of a triangle wave is positioned is in the position of the 4 SC cycle, and, in case of four antennas, peak characteristics show that the apex of a triangle wave is in the position of the 8 SC cycle. These characteristics allow UE to detect the number of transmitting antennas.

As described above, UE specifies the number of transmitting antennas by associating the number of transmitting antennas with the number of subcarriers assigned to subcarrier groups, and detecting the periodicities of the auto-correlation characteristics of received SCH signals.

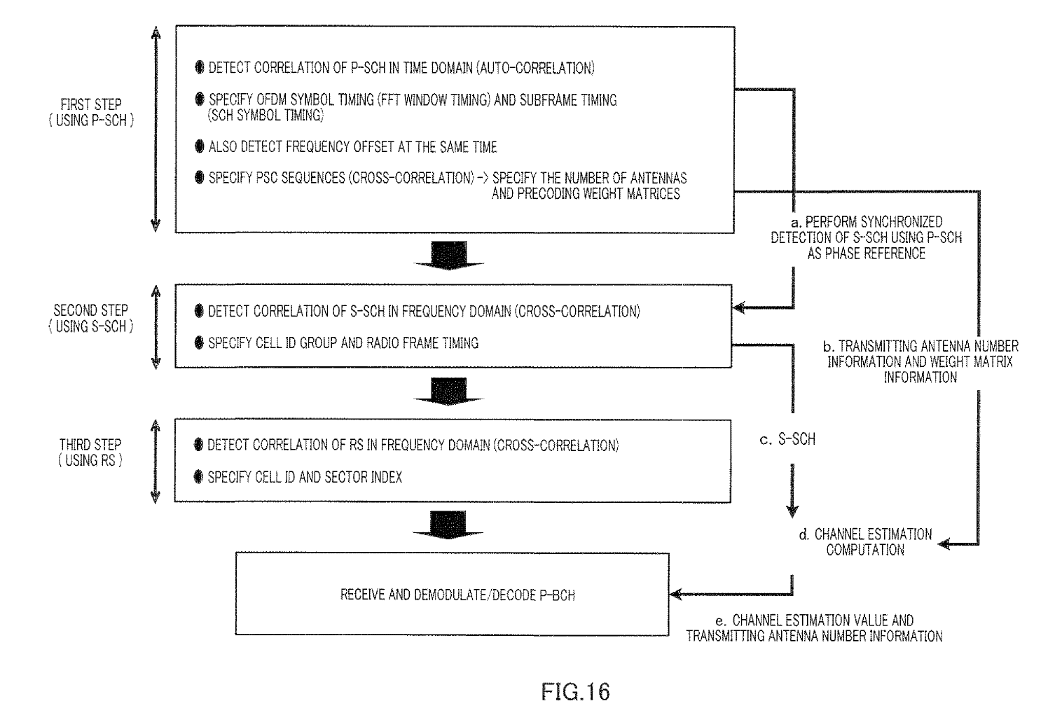

By this means, UE can specify the number of transmitting antennas in the first step of cell search, so that it is possible to receive SCHs to which PVS is applied, regardless of the number of transmitting antennas of Node B, and estimate channels from transmitting antennas. Further, Node B needs not to report the number of transmitting antennas by means of a P-BCH and an S-SCH. To be more specific, bits for reporting the number of transmitting antennas by means of a P-BCH and an S-SCH are not necessary. Note that the fact that the number of transmitting antennas can be specified in the first step of cell search will be described later using FIG. 16.

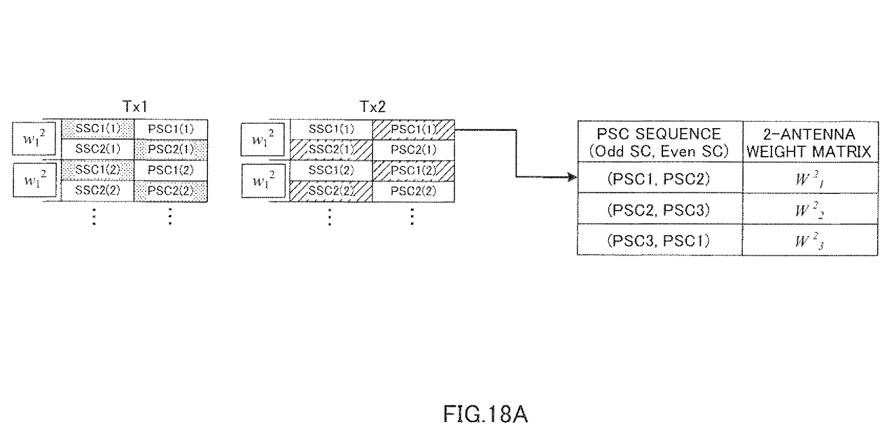

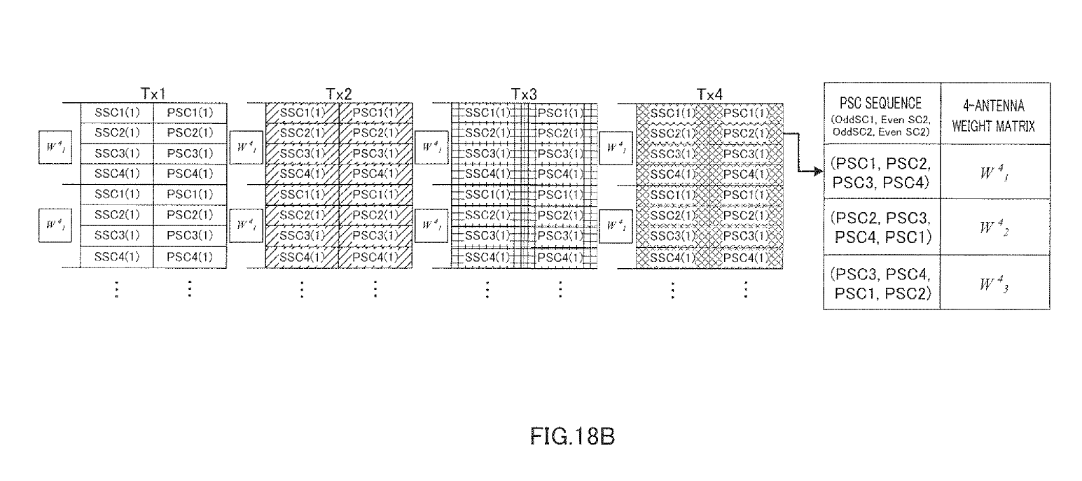

As another transmitting antenna detecting method, associating the number of transmitting antennas with the number of PSC sequences used in P-SCH is possible. Associating the number of transmitting antennas with the number of PSC sequences will be described later using FIG. 18.

Further, a conventional technique of providing transmitting antenna information in an S-SCH may be used in combination.

### Cell Search Steps

FIG. 16 shows the cell search steps. This is an example applied to 3 step cell search of LTE.

(1) First Step: Symbol Synchronization (Using P-SCH)

First, UE detects the correlation of a P-SCH in the time domain, and detects an OFDM symbol timing and subframe timing (i.e. SCH symbol timing). At this time, UE detects the frequency offset at the same time.

In the first step in particular, UE specifies PSC sequences by the cross-correlation based on [Applying PVS to SCH transmission diversity] described above. UE specifies PSC sequences, and specifies the number of transmitting antennas and precoding weight matrices based on [Specifying the number of transmitting antennas] described above.

(2) Second Step: Frame Synchronization (Using S-SCH)

UE performs synchronized detection of an S-SCH using a P-SCH detected in the first step, as the phase reference, and acquires the cross-correlation of the S-SCH in the frequency domain (see FIG. 16 a.) to specify a cell ID group and radio frame timing.

(3) Third Step: Cell ID Identification (Using RS)

UE specifies a cell ID and sector index by detecting the correlation of an RS based on the cross-correlation in the frequency domain.

UE performs channel estimation computation (see FIG. 16 d.) using transmitting antenna number information and precoding weight matrix information detected in the first step (see FIG. 16 b.), and an S-SCH detected in the second step (see FIG. 16 c.). According to the above channel estimation computation, it is possible to specify weight matrices from PSC sequences, so that, while SCHs provide gain thanks to PVS, it is possible to perform channel estimation for a P-BCH assuming an S-SCH as an RS. Further, UE can specify the number of transmitting antennas in the first step of cell search, and consequently can receive SCHs regardless of the number of transmitting antennas of Node B. The channel estimation value for a P-BCH and transmitting antenna number information are provided to receive and demodulate/decode a P-BCH (see FIG. 16 e.).

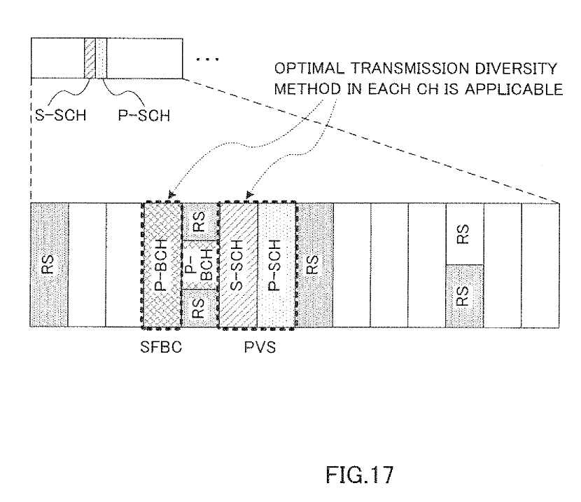

FIG. 17 shows an example of a frame configuration of a signal transmitted from a transmitter. The SSC or S-SCH in the above-described cell search steps is utilized.

UE performs synchronized detection of an S-SCH using a P-SCH as the phase reference. UE demodulates a P-BCH utilizing the channel estimation value for a P-BCH assuming an S-SCH as an RS.

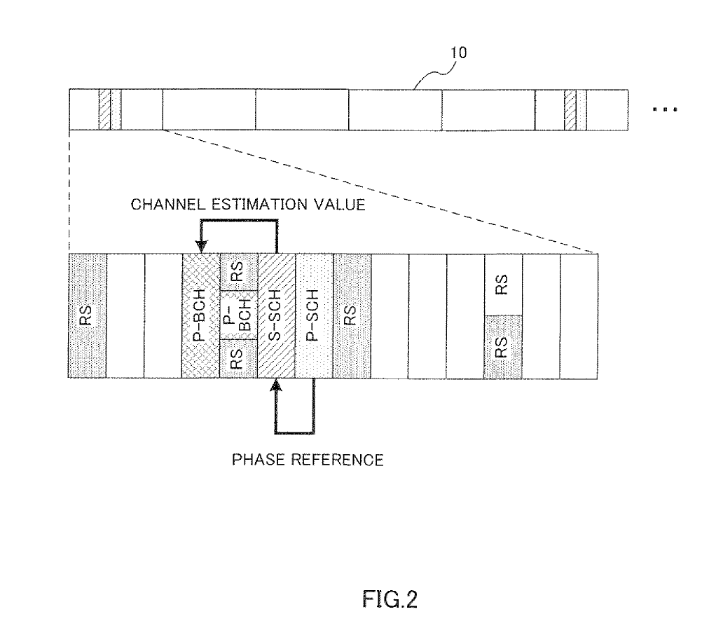

The present invention differs from a conventional example of above FIG. 2 in allowing PVS to be applied as SCH transmission diversity according to the cell search steps, and specifying the number of transmitting antennas in the first step of cell search. Accordingly, as shown by the frame indicated by the solid line in the lower part of FIG. 17, it is possible to apply SFBC to a P-BCH and PVS to an S-SCH and a P-SCH, that is, it is possible to apply an optimal transmission diversity method to each channel.

### Specifying the Number of Transmitting Antennas (2)

The present invention specifies the number of transmitting antennas by associating the number of transmitting antennas with the number of PSC sequences used in a P-SCH, and specifying the number of PSC sequences used for received SCH signals.

FIG. 18 explains the basic concept of associating the number of transmitting antennas with the number of PSC sequences used in a P-SCH. FIG. 18A shows the case of two transmitting antennas (Tx1 and Tx2), and FIG. 18B shows the case of four transmitting antennas (Tx1 to Tx4).

The number of PSC sequences used in a P-SCH is associated with the number of transmitting antennas. As a specific method for associating the number of transmitting antennas with the number of PSC sequences, different PSC sequences are used between, for example, even-numbered subcarriers (SCs) and odd-numbered subcarriers (SCs).

As shown in FIG. 18A, in case of two transmitting antennas (Tx1 and Tx2), two different PSC sequences are used between even-numbered subcarriers (SCs) and odd-numbered subcarriers (SCs). Further, as shown in the table of FIG. 18A, two-antenna precoding weight matrices W²₁, W²₂ and W²₃ are applied to two PSC sequences of different combinations (PSC1 and PSC2), (PSC2 and PSC3) and (PSC3 and PSC1) between odd-numbered subcarriers (odd-numbered SCs) and even-numbered subcarriers (even-numbered SCs).

As shown in FIG. 18B, in case of four transmitting antennas (Tx1 to Tx4), two PSC sequences each for even-numbered subcarriers (SCs) and odd-numbered subcarriers (SCs), that is, four different PSC sequences in total, are used. Further, as shown in the table of FIG. 18B, four-antenna precoding weight matrices W⁴₁, W⁴₂ and W⁴₃ are applied to four PSC sequences of different combinations (PSC1, PSC2, PSC3 and PSC4), (PSC2, PSC3, PSC4 and PSC1) and (PSC3, PSC4, PSC1 and PSC2) between odd-numbered subcarriers (odd-numbered SC1 and 2) and even-numbered subcarriers (even-numbered SC1 and 2).

As described above, the number of transmitting antennas is specified by associating the number of P-SCH sequences with the number of transmitting antennas. Further, the number of transmitting antennas is specified from the number of P-SCH sequences, and weight matrices are specified from the combination of P-SCH sequences.

By this means, UE can specify the number of transmitting antennas in the first step of cell search, so that it is possible to receive SCHs to which PVS is applied, regardless of the number of transmitting antennas of Node B, and estimate channels from transmitting antennas. Further, Node B does not need to report the number of transmitting antennas by means of a P-BCH and an S-SCH, and bits for reporting the number of transmitting antennas by means of a P-BCH and an S-SCH are not required.

Hereinafter, embodiments based on the above basic concept will be explained in detail.

### Embodiment 1

Embodiment 1 provides an example that applies [Applying PVS to SCH transmission diversity] and [Specifying the number of transmitting antennas (1)] described in [Explanation of the principle of the present invention].

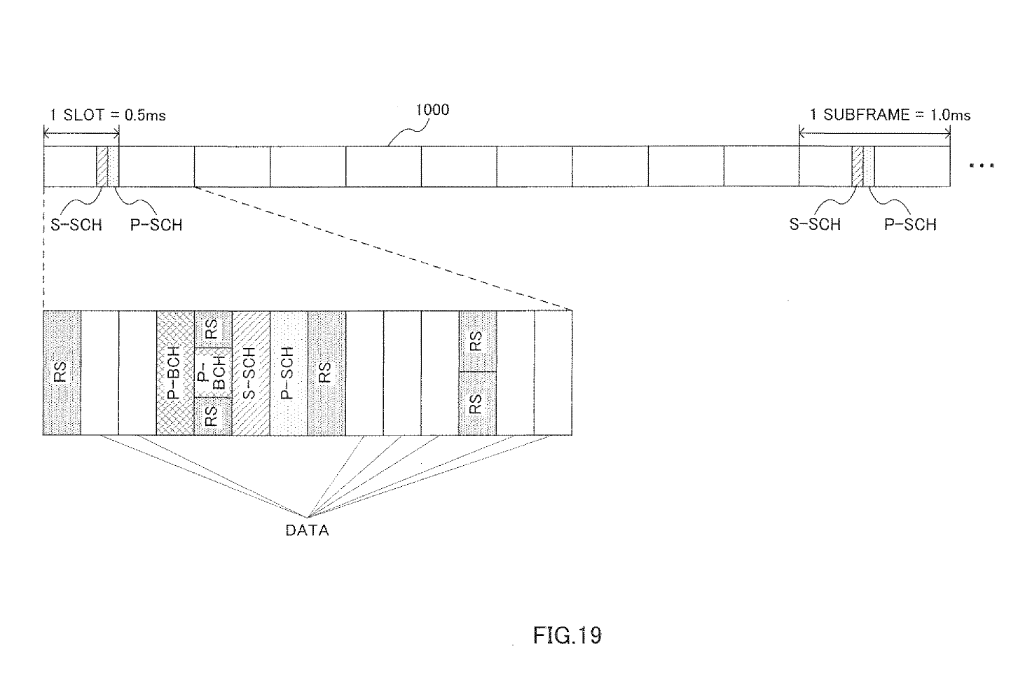

FIG. 19 shows a radio frame configuration assumed in Embodiment 1 of the present invention.

In the upper part of FIG. 19, frame 1000 is formed with a plurality of slots, and, as shown in FIG. 19 by magnifying the main part of frame 1000, the following codes (RSs, P-BCHs, S-SCHs and P-SCHs) are added.

1 slot=0.5 milliseconds and 1 subframe=1 milliseconds (i.e. 2 slots) are defined, and one radio frame length is 10 milliseconds (i.e. 10 subframes). One slot is formed with seven OFDM symbols. SCHs are inserted in the first slots of the first subframe and the sixth subframe, and the interval of insertion is 5 milliseconds. In addition to SCHs, P-BCHs are arranged in the first slot of the first subframe. This P-BCH is transmitted every 40 milliseconds. Further, RSs (Reference Symbols) are arranged in the first OFDM symbol and the fifth OFDM symbol of each slot.

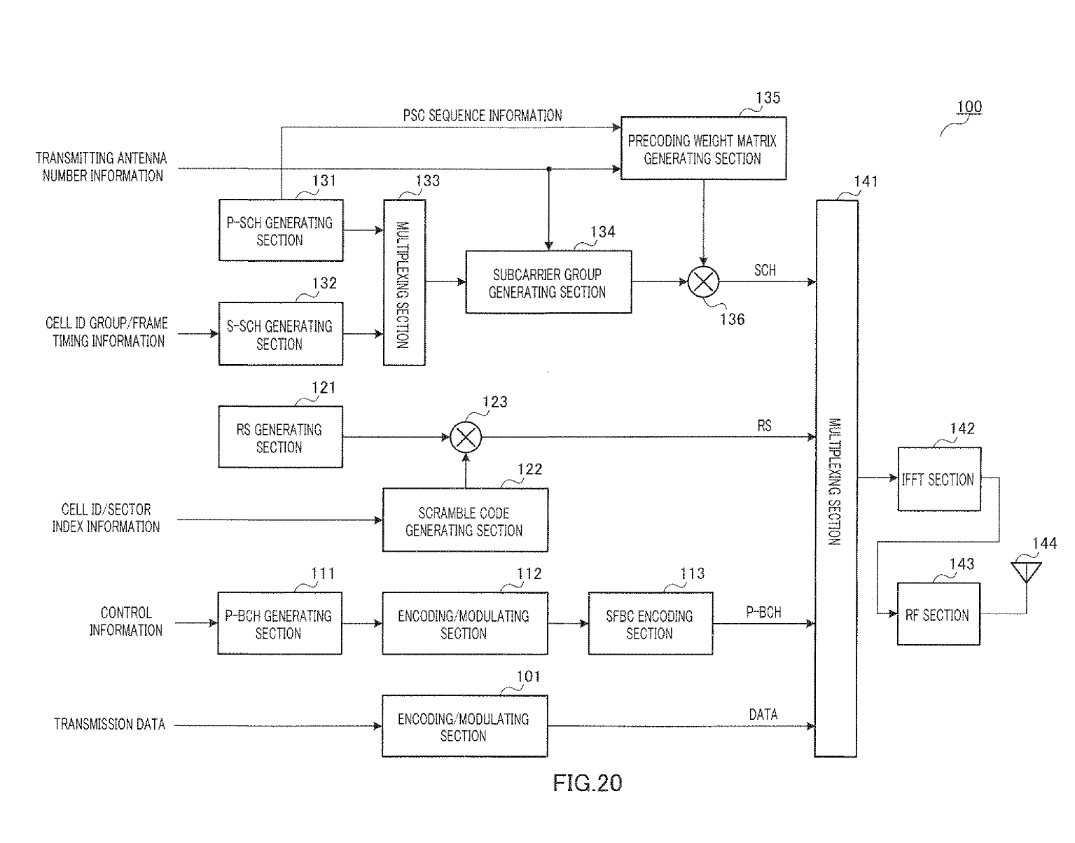

FIG. 20 is a block diagram showing a configuration of the base station apparatus according to Embodiment 1 of the present invention. The present embodiment is an example where the present invention is applied to Node B as a base station that has an OFDM transmitting apparatus. Further, although the OFDM scheme will be explained as the multicarrier communication scheme, the present invention is not limited to the OFDM scheme.

In FIG. 20, Node B 100 is mounted on, for example, a base station apparatus in a mobile communication system.

Node B 100 employs a configuration including encoding/modulating section 101, P-BCH generating section 111, encoding/modulating section 112, SFBC encoding section 113, RS generating section 121, scramble code generating section 122, multiplying section 123, P-SCH generating section 131, S-SCH generating section 132, multiplexing section 133, subcarrier group generating section 134, precoding weight matrix generating section 135, multiplying section 136, multiplexing section 141, IFFT (Inverse Fast Fourier Transform) section 142, RF (Radio Frequency) section 143 and transmitting antenna 144.

Transmission data is inputted to encoding/modulating section 101, and control information is inputted to P-BCH generating section 111. Further, cell ID/sector index information is inputted to scramble code generating section 122, and cell ID group/frame timing information is inputted to S-SCH generating section 132. PSC sequence information from P-SCH generating section 131 is inputted to precoding weight matrix generating section 135. Transmitting antenna number information is inputted to subcarrier group generating section 134 and precoding weight matrix generating section 135.

Encoding/modulating section 101 performs encoding and modulation processing of transmission data, and outputs data to multiplexing section 141.

P-BCH generating section 111 generates a bit sequence matching control information. Encoding/modulating section 112 performs encoding and modulation processing of the generated bit sequence.

SFBC encoding section 113 performs SFBC encoding processing, and outputs the P-BCH to multiplexing section 141.

RS generating section 121 generates an RS (Reference Symbol) sequence corresponding to the pilot signal, Scramble code generating section 122 generates cell-specific scramble code sequences generated based on cell ID/sector index information.

Multiplying section 123 multiplies the generated RS sequence with the cell-specific scramble code sequence, and outputs the RS to multiplexing section 141.

P-SCH generating section 131 generates a P-SCH using PSC sequences assigned on a per cell basis, and outputs the P-SCH to multiplexing section 133. Further, P-SCH generating section 131 outputs the generated PSC sequence information to precoding weight matrix generating section 135.

S-SCH generating section 132 generates an S-SCH using an SSC sequence matching cell ID group/frame timing information.

Multiplexing section 133 time-multiplexes a P-SCH generated by P-SCH generating section 131, with an S-SCH generated by S-SCH generating section 132, and outputs the result to subcarrier group generating section 134.

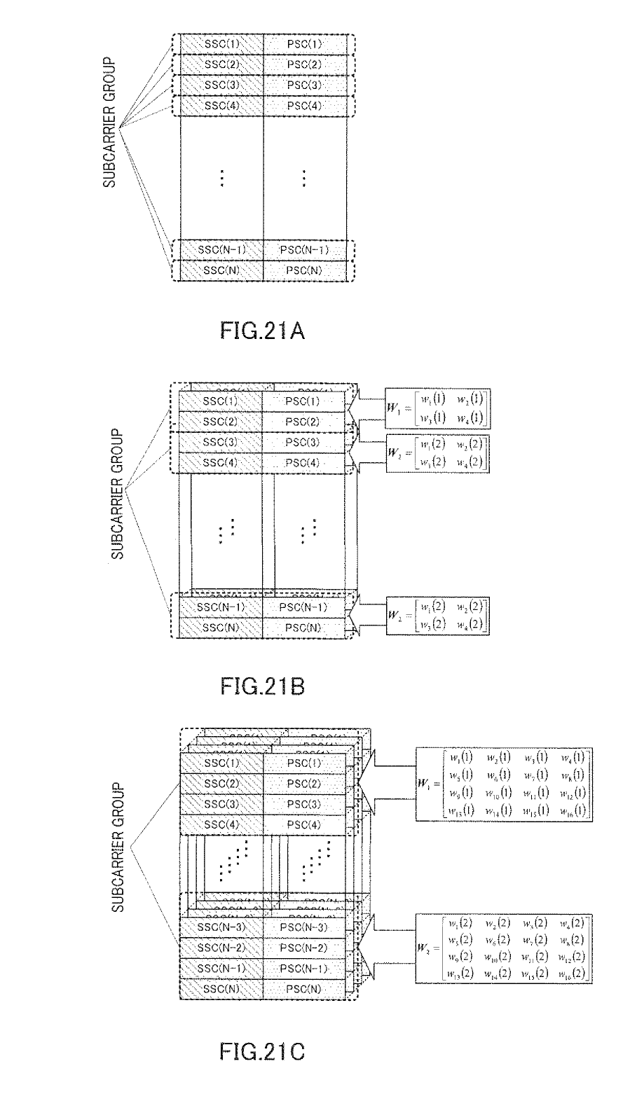

Subcarrier group generating section 134 makes an SCH a subcarrier group based on transmitting antenna number information and outputs the subcarrier group. With the present embodiment, subcarrier group generating section 134 generates for a multicarrier signal a subcarrier group formed with a plurality of subcarriers. Further, subcarrier group generating section 134 associates the number of transmitting antennas with the number of subcarriers of subcarrier groups formed with a plurality of subcarriers and/or the periodicity, and makes PSC sequences from P-SCH generating section 131 a subcarrier group based on the number of subcarriers and/or the periodicity associated with the number of transmitting antennas, and outputs the subcarrier group. The details will be described later using FIG. 21.

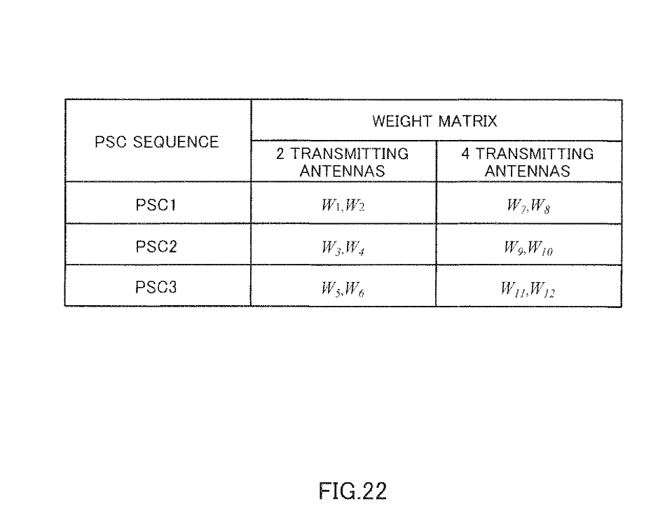

Precoding weight matrix generating section 135 outputs precoding weight matrices based on PSC sequence information from P-SCH generating section 131 and transmitting antenna number information. With the present embodiment, precoding weight matrix generating section 135 sets PSC sequences used for P-SCHs uniquely associated with precoding weight matrices that vary between subcarrier groups, and generates precoding weight matrices associated with a plurality of set PSC sequences. The details will be described later using FIG. 22.

Multiplying section 136 multiplies generated SCHs with precoding weight matrices, and outputs the result to multiplexing section 141.

Multiplexing section 141 performs time-multiplexing processing to generate the radio frame shown in FIG. 19, and forms a transmission signal.

IFFT section 142 performs IFFT processing to transform time domain data into frequency domain data, and forms an OFDM symbol.

RF section 143 up-converts a baseband frequency signal to an RF band frequency signal.

Transmitting antenna 144 transmits the RF band frequency signal into the air.

UE that receives multicarrier signals specifies the precoding weight matrices of PVS and can estimate channels from transmitting antennas, and consequently Node B 100 can adopt transmission diversity for applying PVS to the frequency domain of SCHs using the precoding weight matrices.

Next, subcarrier group generating section 134 and precoding weight matrix generating section 135 will be explained in detail.

### Subcarrier Group Generating Section 134

FIG. 21 shows how subcarrier group generating section 134 generates subcarrier groups. FIG. 21A shows the case of one transmitting antenna (Tx1), FIG. 21B shows the case of two transmitting antennas (Tx1 and Tx2) and FIG. 21C shows the case of four transmitting antennas (Tx1 to Tx4).

Subcarrier group generating section 134 generates subcarrier groups in the frequency domain of SCHs, based on transmitting antenna number information.

As shown in FIG. 21A, in case of one transmitting antenna, subcarrier groups are each formed with one subearrier, and are not multiplied with a precoding weight.

As shown in FIG. 21B, in case of two transmitting antennas, subcarrier groups are formed with two subcarriers, and are multiplied with precoding weight matrices. Precoding weight matrices W₁ and W₂ of two transmitting antennas are 2×2 matrices.

As shown in FIG. 21C, in case of four transmitting antennas, subearrier groups are each formed with four subcarriers, and are multiplied with precoding weight matrices W₁ and W₂ of 4×4.

### Precoding Weight Matrix Generating Section 135

FIG. 22 shows a table listing correspondences between PSC sequences and precoding weight matrices. The table of FIG. 22 is a mapping table of PSC sequences and precoding weight matrices.

Precoding weight matrix generating section 135 generates precoding weight matrices based on transmitting antenna number information and PSC sequence information.

Now, three kinds of PSC sequences are assumed and two kinds of weights are assigned to each PSC sequence. Two kinds of weights are applied to both of even-numbered subcarrier groups and odd-numbered subcarrier groups. Examples of precoding weight matrices are shown in following equation 3.

$$\begin{matrix}( Equation 3 ) & \\ {W}_{1} = [ \begin{matrix}1 & 1 \\ 1 & - 1\end{matrix} ] , {W}_{2} = [ \begin{matrix}1 & 1 \\ 1 & - 1\end{matrix} ] \\ {W}_{7} = [ \begin{matrix}1 & 1 & 1 & 1 \\ 1 & 1 & - 1 & - 1 \\ 1 & - 1 & 1 & - 1 \\ 1 & - 1 & - 1 & 1\end{matrix} ] , {W}_{8} = [ \begin{matrix}1 & 1 & - 1 & - 1 \\ 1 & 1 & 1 & 1 \\ 1 & - 1 & - 1 & 1 \\ 1 & - 1 & 1 & - 1\end{matrix} ] & [ 3 ]\end{matrix}$$

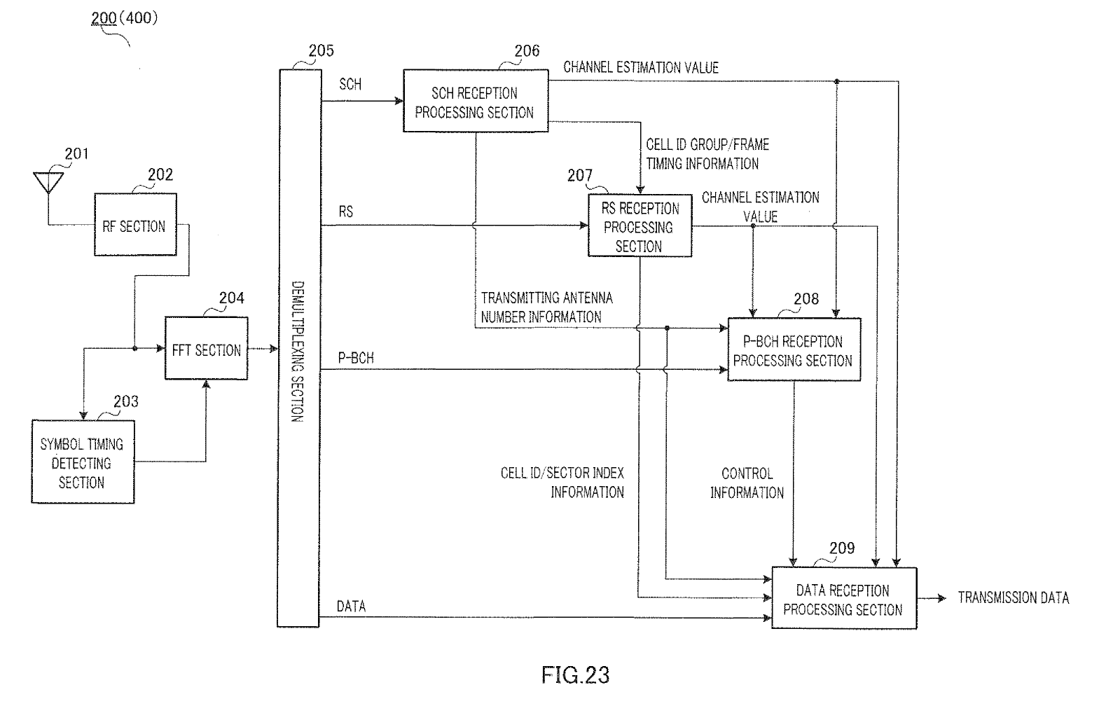

FIG. 23 is a block diagram showing a configuration of a mobile station apparatus according to Embodiment 1 of the present invention. The present embodiment is an example where a mobile station apparatus that has a multicarrier receiving apparatus is applied to UE.

In FIG. 23, UE 200 is a receiver that performs radio communication with Node B 100 of FIG. 20, and is mounted on, for example, the mobile station apparatus in the mobile communication system.

UE 200 employs a configuration including antenna 201, RF section 202, symbol timing detecting section 203, FFT section 204, demultiplexing section 205, SCH reception processing section 206, RS reception processing section 207, P-BCH reception processing section 208 and data reception processing section 209.

RF section 202 down-converts the signal received through antenna 201, into a baseband signal.

Symbol timing detecting section 203 detects the OFDM symbol timing (i.e. FFT window timing) and SCH symbol timing by detecting the auto-correlation of the received signal. This corresponds to the first half of the first step of the cell search steps.

FFT section 204 performs FFT processing using the detected FFT window timing.

Demultiplexing section 205 demultiplexes the received signal to an SCH, RSs, P-BCHs and data, and outputs the demultiplexed SCH to SCH reception processing section 206, RSs to RS reception processing section 207, P-BCHs to P-BCH reception processing section 208 and data to data reception processing section 209.

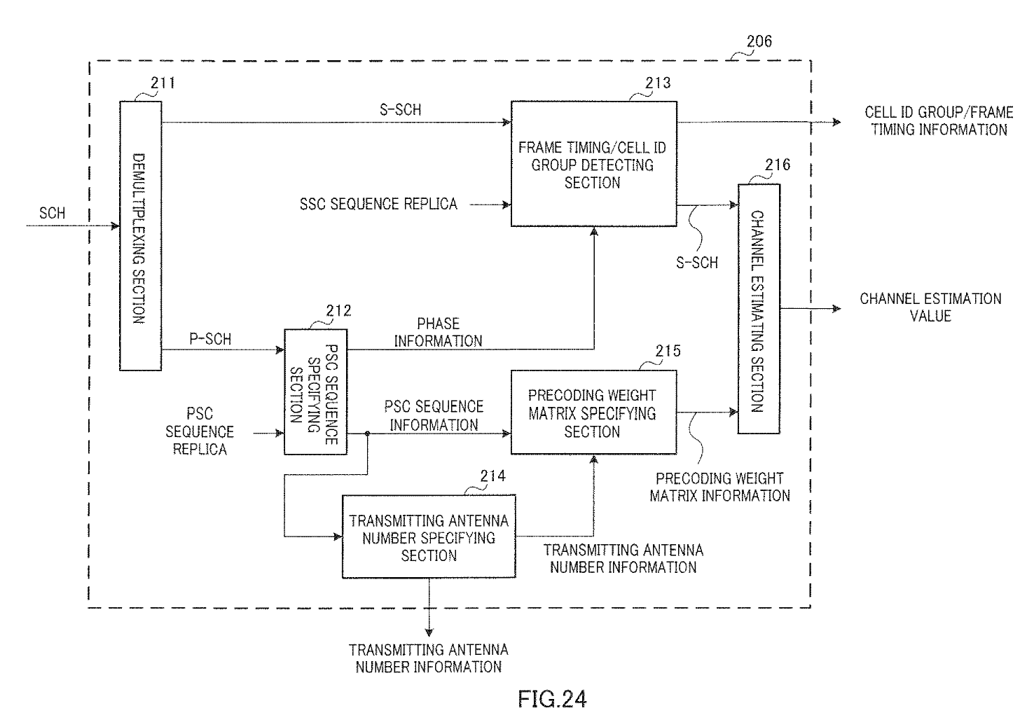

SCH reception processing section 206 performs processing corresponding to the second half of the first step of the cell search steps of FIG. 16 and the second step and outputs a channel estimation value, cell ID group/frame timing information and transmitting antenna number information. With the present embodiment, SCH reception processing section 206 receives SCHs to which PVS is applied. The details will be described later using FIG. 24 to FIG. 26.

RS reception processing section 207 performs processing corresponding to the third step of the cell search steps of FIG. 16 based on the cell ID group/frame timing information and outputs cell ID/sector index information. Further, RS reception processing section 207 performs channel estimation based on the RSs, and outputs the channel estimation value to P-BCH reception processing section 208 and data reception processing section 209.

P-BCH reception processing section 208 performs reception processing using the transmitting antenna number information from SCH reception processing section 206 and the channel estimation value from RS reception processing section 207, and outputs control information to data reception processing section 209.

Data reception processing section 209 performs reception processing such as demodulation and decoding based on the channel estimation value, control information, cell ID/sector index information and transmitting antenna number information to acquire received data.

Next, SCH reception processing section 206, RS reception processing section 207 and P-BCH reception processing section 208 will be explained in detail.

### SCH Reception Processing Section 206

SCH reception processing section 206 performs processing corresponding to the second half of the first step of cell search and the second step of cell search of the cell search steps of FIG. 16.

FIG. 24 is a block diagram showing the detailed configuration of SCH reception processing section 206.

In FIG. 24, SCH reception processing section 206 employs a configuration including SCH reception processing section 206, demultiplexing section 211, PSC sequence specifying section 212, frame timing/cell ID group detecting section 213, transmitting antenna number specifying section 214, precoding weight matrix specifying section 215 and channel estimating section 216.

Demultiplexing section 211 demultiplexes an SCH into a P-SCH and an S-SCH, and outputs the P-SCH to PSC sequence specifying section 212 and outputs the S-SCH to frame timing/cell ID group detecting section 213.

PSC sequence specifying section 212 detects the cross-correlation between the P-SCH and PSC sequence replicas, to specify PSC sequences used in the P-SCH. PSC sequence specifying section 212 outputs phase information specified by detecting the cross-correlation, to frame timing/cell ID group detecting section 213, and outputs the P-SCH and PSC sequence information to transmitting antenna number specifying section 214.

Frame timing/cell ID group detecting section 213 detects the cross-correlation between an S-SCH and SSC sequence replicas based on the phase information from PSC sequence specifying section 212, to specify an S-SCH and a cell ID group/frame timing. Frame timing/cell ID group detecting section 213 outputs the specified cell ID group/frame timing information to RS reception processing section 207 (FIG. 23), and outputs the S-SCH to channel estimating section 216. This is the processing corresponding to the second step of the cell search steps of FIG. 16.

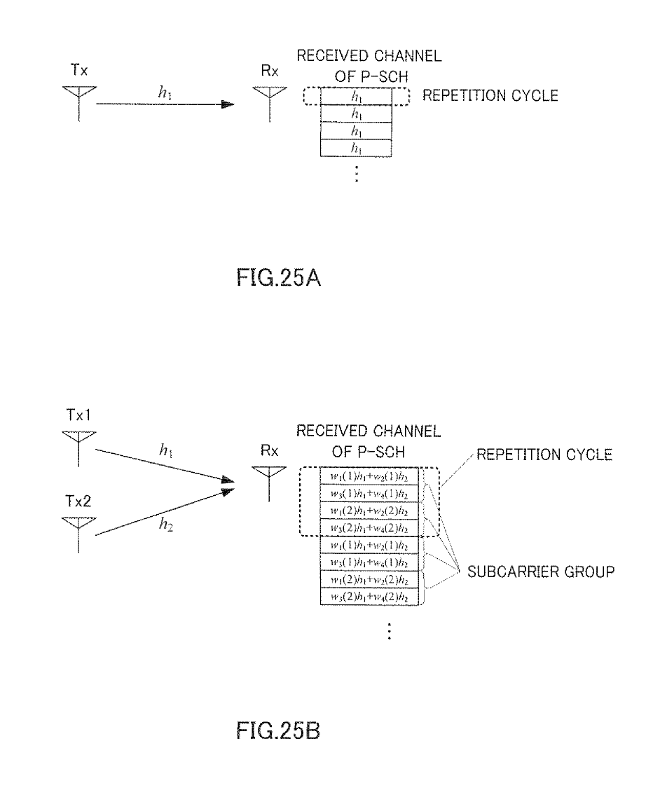

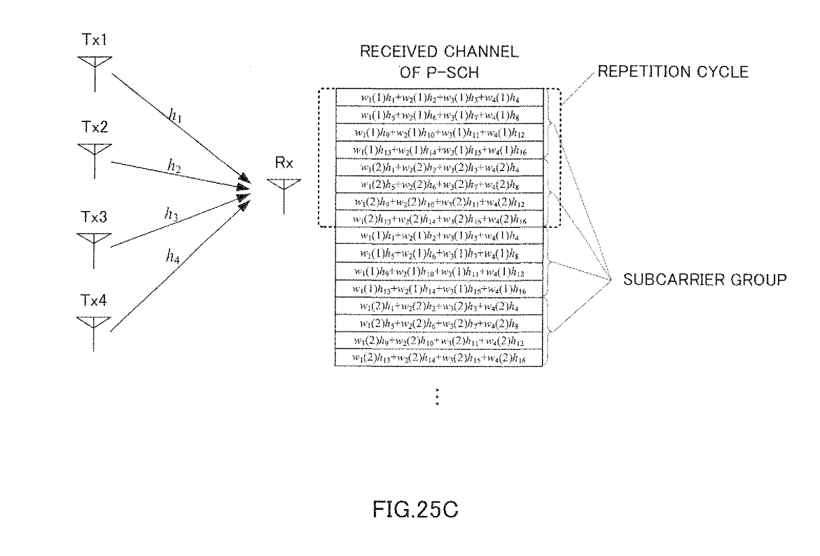

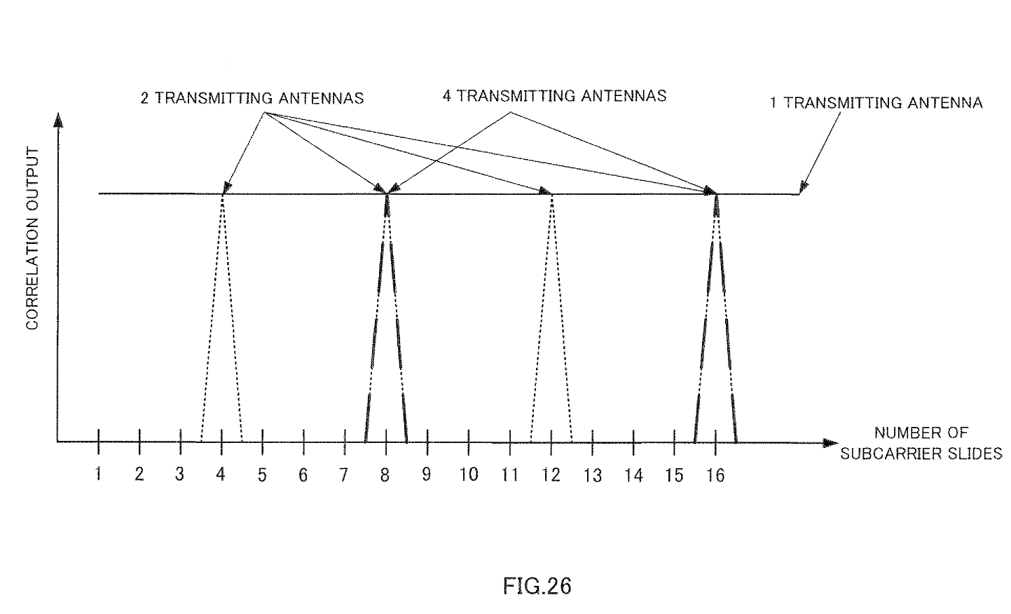

Transmitting antenna number specifying section 214 specifies the number of transmitting antennas by dividing the received P-SCH by the specified PSC sequences, and then detecting the auto-correlation. To specify the number of transmitting antennas, the method explained in detail in above [Specifying the number of transmitting antenna (1)], is applied. The operation of transmitting antenna number specifying section 214 of the present embodiment will be explained with reference to FIG. 25 and FIG. 26. FIG. 25 and FIG. 26 correspond to above FIG. 14 and FIG. 15, respectively.

FIG. 25 shows the state of a received channel of a P-SCH per transmitting antenna. FIG. 25A shows a received channel of a P-SCH in case of one transmitting antenna (Tx), FIG. 25B shows received channels of P-SCHs in case of two transmitting antennas (Tx1 and Tx2) and FIG. 25C shows received channels of P-SCHs in case of four transmitting antennas (Tx1 to Tx4). FIG. 26 shows auto-correlation characteristics of received channels of P-SCHs of FIGS. 25A to C.

As shown in FIG. 25A, with one transmitting antenna (Tx), no weight is multiplied, and therefore received channels of P-SCHs are equal between all subcarriers and the repetition cycle of channels is one subcarrier.

As shown in FIG. 25B, with two transmitting antennas (Tx1 and Tx2), precoding weight matrices are multiplied with each subcarrier group, different weight matrices are multiplied with even-numbered subcarrier groups and odd-numbered subcarrier groups and therefore the repetition cycle of a received channel of a P-SCH is four subcarriers.

As shown in FIG. 25C, with four transmitting antennas (Tx1 to Tx4), the repetition cycle of a P-SCH is eight subcarriers.

Further, as shown in FIG. 26, in case of one transmitting antenna, a peak is 1 SC cycle (that is, a peak is detected at all times). In case of two transmitting antennas, peak characteristics show that the apex of a triangle wave is positioned is in the position of the 4 SC cycle, and, in case of four transmitting antennas, peak characteristics show that the apex of a triangle wave is in the position of the 8 SC cycle. Transmitting antenna number specifying section 214 detects the number of transmitting antennas based on these characteristics.

Back to FIG. 24, by cross-checking the PSC sequence information and transmitting antenna number information received as input, with the table that associates PSC sequences with precoding weight matrices shown in above FIG. 22, precoding weight matrix specifying section 215 specifies precoding weight matrices used in Node B 100.

Channel estimating section 216 performs channel estimation using an S-SCH and precoding weight matrix information, and outputs the channel estimation value.

### RS Reception Processing Section 207

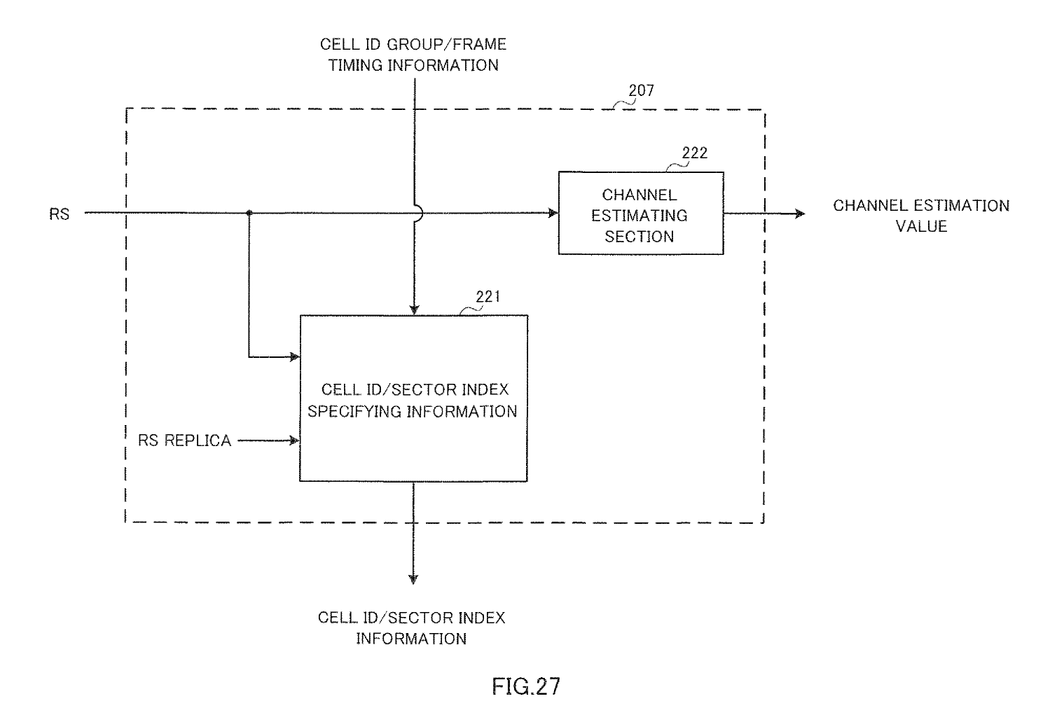

FIG. 27 is a block diagram showing a detailed configuration of RS reception processing section 207.

In FIG. 27, RS reception processing section 207 employs a configuration including cell ID/sector index specifying section 221 and channel estimating section 222.

Cell ID/sector index specifying section 221 finds the cross-correlation between received RSs and RS replicas based on the RS signal and cell ID group/frame timing information received as input, and outputs cell ID/sector index information. Cell ID/sector index specifying section 221 can limit the number of RS replica candidates for detecting the cross-correlation, by acquiring the cell ID group/frame timing information.

Channel estimating section 222 performs channel estimation and outputs a channel estimation value.

### P-BCH Reception Processing Section 208

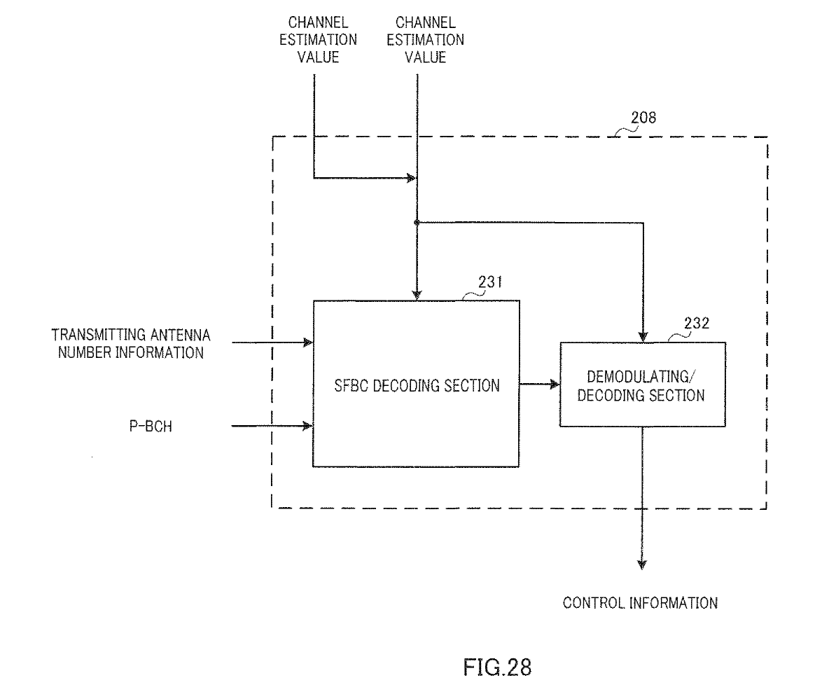

FIG. 28 is a block diagram showing a detailed configuration of P-BCH reception processing 208.

In FIG. 28, P-BCH reception processing section 208 employs a configuration including SFBC decoding section 231 and demodulating/decoding section 232.

With the present embodiment, a P-BCH is subjected to SFBC encoding.

SFBC decoding section 231 performs SFBC decoding processing based on a received P-BCH signal, transmitting antenna number information and a channel estimation value.

Demodulating/decoding section 232 performs demodulation and decoding processing, and outputs control information to data reception processing section 209 (FIG. 23). This control information includes information about the transmission bandwidth of a cell and so on.

Hereinafter, the operation of UE 200 configured as described will be explained.

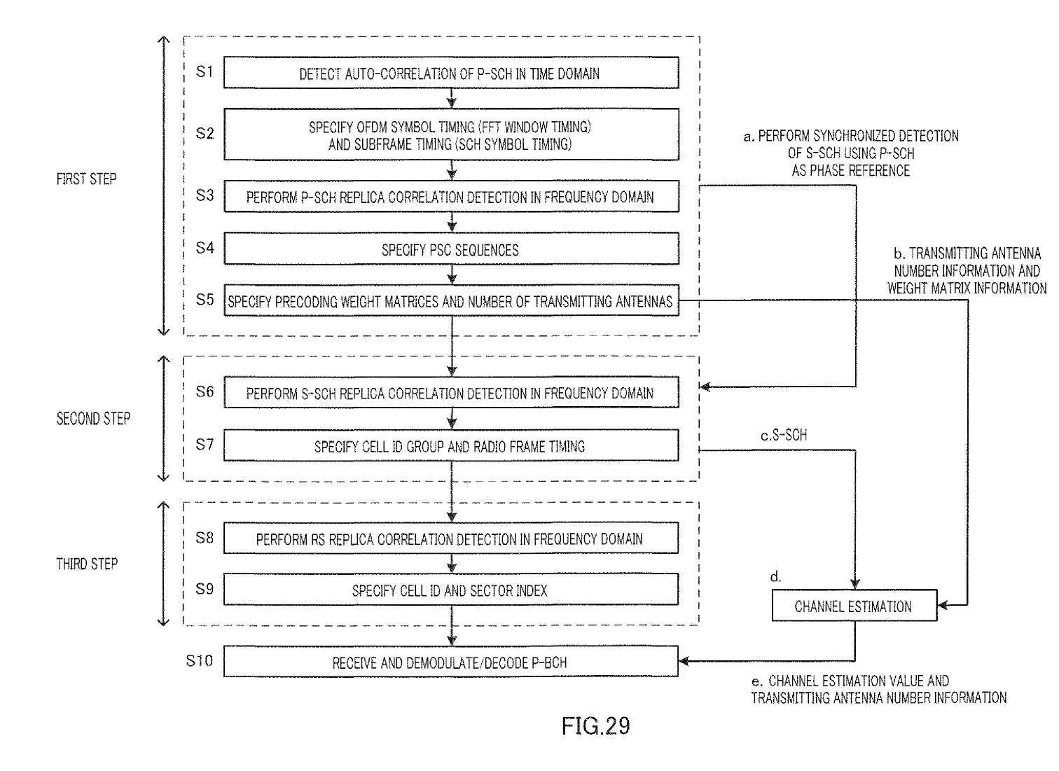

FIG. 29 is a flowchart showing the cell search procedure according to the present embodiment. This cell search procedure corresponds to the cell search steps in above FIG. 16.

(1) First Step

First, in step S1, UE 200 receives a signal from Node B 100, buffers the received signal for a certain period and then calculates the auto-correlation of the received signal. At this time, a peak value is detected in the auto correlation characteristics of a P-SCH of the received signal (see above FIG. 8), so that it is possible to specify an OFDM symbol timing (i.e. one symbol section) and SCH symbol timing (i.e. the position of the SCH) in the received signal.

In step S2, after the FFT window timing is specified, UE 200 performs FFT processing of the received P-SCH and detects the correlation between the received P-SCH and P-SCH replicas in step S3. To be more specific, symbol timing detecting section 203 of UE 200 finds the cross-correlation of the S-SCH in the frequency domain using the P-SCH detected in the first step as the phase reference, and synchronizes an S-SCH (see FIG. 29 a.). Further, UE 200 specifies cell ID groups and radio frame timings.

Then, in step S4, PSC sequence specifying section 212 (FIG. 24) of SCH reception processing section 206 specifies PSC sequences used in the P-SCH.

In step S5, PSC sequences are associated with precoding weight matrices on a one-by-one basis (see the table of above FIG. 12), and therefore precoding weight matrix specifying section 215 (FIG. 24) of SCH reception processing section 206 specifies precoding matrices multiplied with subcarrier groups of SCHs, by specifying PSC sequences. Further, transmitting antenna number specifying section 214 of SCH reception processing section 206 (FIG. 24) specifies the number of transmitting antennas by detecting the auto-correlation of sequences dividing received PSC sequences by replica PSC sequences, and detecting the periodicity of auto-correlation characteristics.

In the first step, PSC sequences are specified by cross-correlation based on [Applying PVS to SCH transmission diversity] described in [Explanation of the principle of the present invention]. By specifying PSC sequences and the number of transmitting antennas, precoding matrices are specified (see FIG. 29 b.)

(2) Second Step

In step S6, frame timing/cell ID group detecting section 213 of SCH reception processing section 206 (FIG. 24) performs S-SCH replica correlation detection of performing synchronized detection (i.e. coherent detection) of an S-SCH using a P-SCH as the phase reference, in the frequency domain.

In step S7, frame timing/cell ID group detecting section 213 specifies a cell ID group and radio frame timing based on a replica correlation detection result. Further, channel estimating section 216 of SCH reception processing section 206 (FIG. 24) performs channel estimation using an S-SCH. To be more specific, channel estimating section 216 performs channel estimation computation (see FIG. 29 d.) based on the transmitting antenna number information and precoding weight matrix information detected in the first step (see FIG. 29 b.), and the S-SCH detected in the second step (see FIG. 29 c.).

The precoding weight matrices and the number of transmitting antennas are specified in the first step, so that channel estimating section 216 can estimate channels from transmitting antennas by dividing received S-SCH signals by replica SSC sequences, and multiplying the division results with precoding weight matrices as shown in above equation 2. The channel estimation results are utilized to demodulate and decode a P-BCH.

(3) Third Step

In step S8, cell ID/sector index specifying section 221 of RS reception processing section 207 (FIG. 27) performs replica correlation detection of received RSs (Reference Symbols) subjected to the FFT in the frequency domain.

In step S9, cell ID/sector index specifying section 221 detects a cell ID that belongs to the group detected in the second step and specifies the sector index.

(4) Fourth Step

In step S10, P-BCH reception processing section 208 receives, and demodulates and decodes a P-BCH (see FIG. 29 e.). SFBC is applied to a P-BCH as a transmission diversity method, and therefore SFBC decoding section 231 of P-BCH reception processing section 208 (FIG. 28) performs SFBC reception processing based on the channel estimation value and transmitting antenna number information determined using an S-SCH.

Channel estimation computation shown in FIG. 29 d. allows weight matrices to be specified from PSC sequences, so that, while SCHs provide gain thanks to PVS, it is possible to perform channel estimation for a P-BCH assuming an S-SCH as an RS. Further, UE 200 can specify the number of transmitting antennas in the first step of cell search, and receive SCHs regardless of the number of transmitting antennas of Node B 100.

As described above, by associating PSC sequences with precoding weight matrices, while PVS of optimal performance is applied to SCHs as SCH transmission diversity, estimation of channels from transmitting antennas is realized using an S-SCH. Conventionally, in case where PVS is applied to SCHs, PVS also had to be applied to P-BCHs. However, with the present embodiment, it is possible to apply optimal transmission diversity methods to SCHs and P-BCHs, and improve cell search performance and receiving performance of P-BCHs.

Further, with the present embodiment, although the same transmission diversity method is applied to P-SCHs and S-SCHs in compliance with the specification of 3GPP LTE, as described in above equation 1 and above equation 2, it is equally possible to acquire channel estimation values using PSCs and, consequently, apply SFBC to S-SCHs.

As explained above in detail, according to the present embodiment, when PVS is applied to the frequency domain of SCHs, precoding weight matrices are specified by applying different precoding weights to subcarrier groups, associating a plurality of PSC sequences with precoding weight matrices and specifying PSC sequences. As described above, by associating precoding weight matrices with PSC sequences, it is possible to estimate channels from transmitting antennas using S-SCHs. By this means, while SCHs provide diversity gain thanks to PVS, it is possible to improve receiving performance of P-BCHs using channel estimation values from S-SCHs. Further, by providing subcarrier groups in the frequency domain and changing precoding weight vectors applied to neighboring subcarrier groups, it is possible to prevent side lobes from being produced when the auto-correlation is detected.

Particularly, as shown in FIG. 29, if PSC sequences are specified in the first step of cell search, precoding weight matrices of PVS are specified, so that, while SCHs provide gain thanks to PVS, it is possible to estimate channels from transmitting antennas. Further, by applying different precoding weights on a per subcarrier group basis, it is possible to prevent side lobes from being produced when the auto-correlation in P-SCHs is detected.

Further, with the present embodiment, the number of transmitting antennas is specified by associating the number of transmitting antennas with the number of subcarriers assigned to subcarrier groups, and detecting the periodicity of the auto-correlation characteristics of received SCH signals. By this means, UE 200 can specify the number of transmitting antennas in the first step of cell search, so that it is possible to receive SCHs to which PVS is applied, regardless of the number of transmitting antennas of Node B 100 and estimate channels from transmitting antennas. Further, it is not necessary to report the number of transmitting antennas by means of P-BCHs and S-SCHs.

### Embodiment 2

Embodiment 2 provides an example where [Applying PVS to SCH transmission diversity] and [Specifying the number of transmitting antennas (2)] described in [Explanation of the principle of the present invention] are applied to a radio communication system.

Embodiment 2 differs from Embodiment 1 in the method of reporting the number of transmitting antennas.

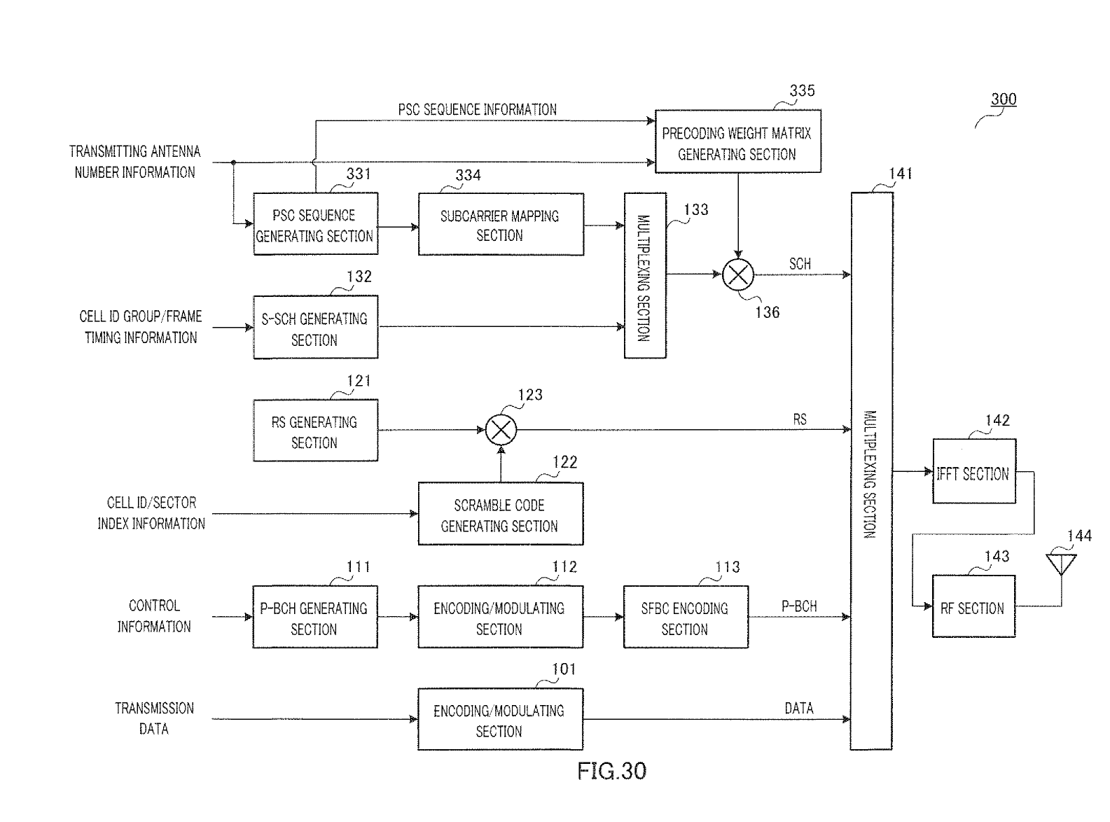

FIG. 30 is a block diagram showing a configuration of a base station apparatus according to Embodiment 2 of the present invention. To explain the present embodiment, the same components as in FIG. 20 will be assigned the same reference numerals and explanation of overlapping portions will be omitted.

In FIG. 30, Node B 300 employs a configuration including encoding/modulating section 101, P-BCH generating section 111, encoding/modulating section 112, SFBC encoding section 113, RS generating section 121, scramble code generating section 122, multiplying section 123, PSC sequence generating section 331, S-SCH generating section 132, multiplexing section 133, subcarrier mapping section 334, precoding weight matrix generating section 335, multiplying section 136, multiplexing section 141, IFFT section 142, RF section 143 and transmitting antenna 144.

Node B 300 differs from Node B 100 of FIG. 20 in inputting transmitting antenna number information to PSC sequence generating section 331 instead of subearrier group generating section 134 and providing subearrier mapping section 334.

Hereinafter, portions different from Embodiment 1 will be explained.

PSC sequence generating section 331 generates a number of PSC sequences based on transmitting antenna number information using PSC sequences assigned to each cell, and outputs the PSC sequences to subcarrier mapping section 334. Further, PSC sequence generating section 331 outputs the generated PSC sequence information to precoding weight matrix generating section 335.

Subcarrier mapping section 334 maps a plurality of PSC sequences on subcarrier groups.

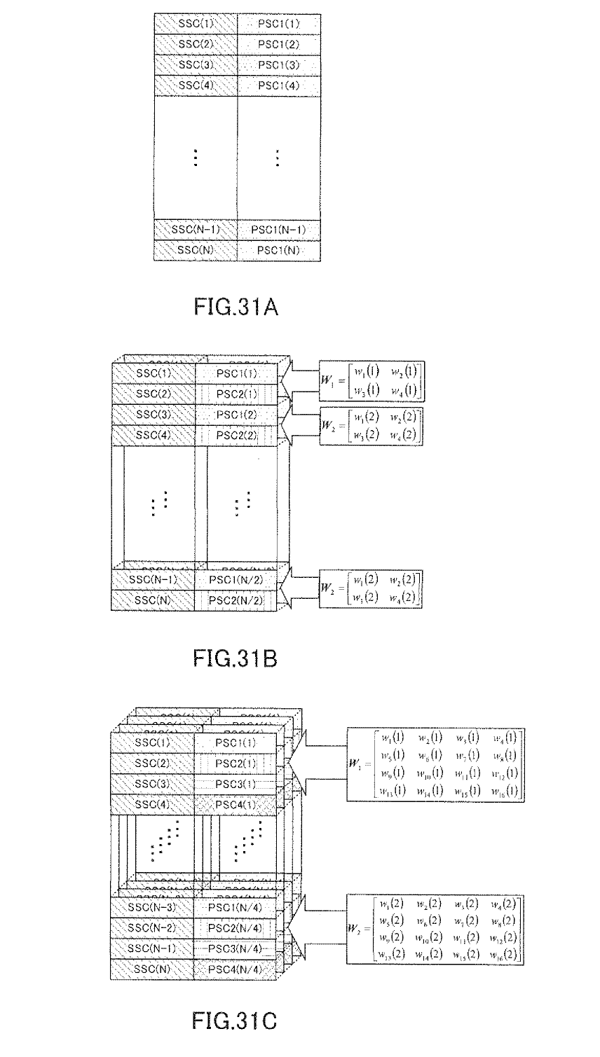

FIG. 31 explains how subearrier mapping section 334 maps PSC sequences for each transmitting antenna. FIG. 31A shows the case of one transmitting antenna (Tx1), FIG. 31B shows the case of two transmitting antennas (Tx1 and Tx2) and FIG. 31C shows the case of four transmitting antennas (Tx1 to Tx4).

As shown in FIG. 31A, in case of one transmitting antenna, the number of PSC sequences used for a P-SCH is one.

As shown in FIG. 31B, in case of two transmitting antennas, the number of PSC sequences to be used is two. Two kinds of PSC sequences are mapped on subcarriers, and therefore the sequence length of one PSC sequence is N/2.

As shown in FIG. 31C, in case of four transmitting antennas, the number of PSC sequences to be used is four. Four kinds of PSC sequences are mapped on subcarriers, and therefore the sequence length of one PSC sequence is N/4.

Multiplexing section 133 time-multiplexes a P-SCH mapped in subcarrier mapping section 334 and an S-SCH generated in S-SCH generating section 132, and outputs the result to multiplying section 136.

Precoding weight matrix generating section 335 generates preceding weight matrices based on the transmitting antenna number information and PSC sequence information. With the present embodiment, preceding weight matrix generating section 335 associates the number of transmitting antennas with the number of PSC sequences to be used for a P-SCH.

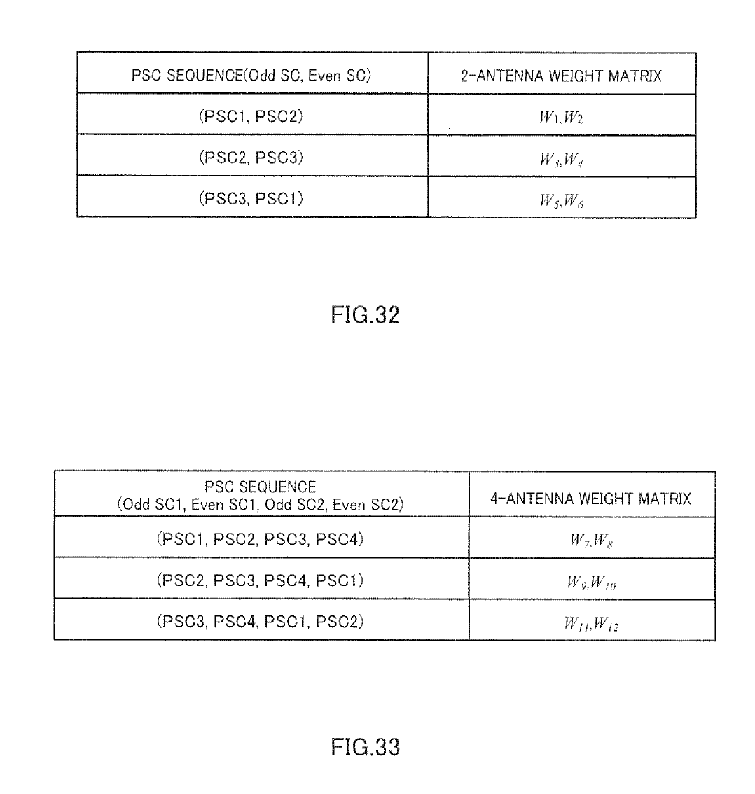

FIG. 32 and FIG. 33 show mapping tables of PSC sequences and precoding weight matrices. The table of FIG. 32 shows correspondences between PSC sequences and preceding weight matrices of two transmitting antennas, and the table of FIG. 33 shows correspondences between PSC sequences and precoding weight matrices of four transmitting antennas.

In case of two transmitting antennas, a pair of PSC sequences assigned to even-numbered subcarriers and odd-numbered subcarriers are associated with preceding weight matrices.

Further, in case of four transmitting antennas, the order of four PSC sequences assigned to a subcarrier group formed with two even-numbered subcarriers and two odd-numbered subcarriers, is associated with preceding weight matrices.

Embodiment 2 is an example where [Specifying the number of transmitting antennas (2)] described in above FIG. 18 is applied to a radio communication system. According to [Explanation of the principle] of above FIG. 18, different PSC sequences are used for even-numbered subcarriers (SCs) and odd-numbered subcarriers (SCs), and two-antenna precoding weight matrices W²₁, W²₂, and W²₃ or four-antenna precoding weight matrices W⁴₁, W⁴₂, and W⁴₃ are applied to different PS sequences. Any method is possible as long as it associates the number of PSC sequences with the number of transmitting antennas, and, as shown in the tables of above FIGS. 18A and B, one kind of precoding weight matrices (W²₁, W²₂ and W²₃ or W⁴₁, W⁴₂ and W⁴₃) does not cause a problem to specify the number of transmitting ID antennas. However, if there is one kind of precoding weight matrices, the regularity is produced as shown in above FIG. 8 when the auto-correlation is detected using P-SCHs, and side lobes are likely to be produced in correlation characteristics. Therefore, with the present embodiment, as shown in FIG. 32 and FIG. 33, two kinds of precoding weight matrices (W₁ & W₂, W₃ & W₄, and W₅ & W₆ or W₇ & W₈, W₉ & W₁₀, and W₁₁ & W₁₂) are prepared, and one set in these two kinds of precoding weight matrices are adequately used. By so doing, it is possible to specify the number of transmitting antennas in the first step of cell search while randomizing weights assigned to subcarriers to undermine the regularity and preventing in advance the side lobes from being produced.

The overall configuration of the mobile station apparatus according to Embodiment 2 of the present invention is the same as in FIG. 23, and therefore explanation thereof will be omitted.

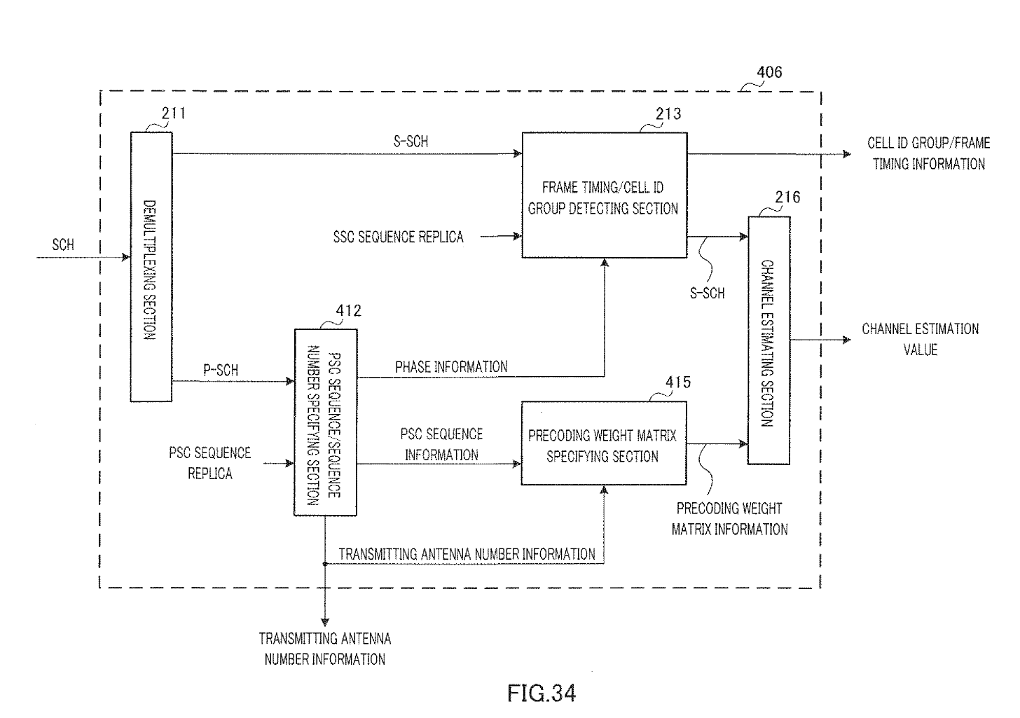

FIG. 34 is a block diagram showing a detailed configuration of SCH reception processing section 406 of UE 400 according to the present embodiment. The same components as in FIG. 24 will be assigned the same reference numerals and explanation of overlapping portions will be omitted.

SCH reception processing section 406 of UE 400 is adopted instead of SCH reception processing section 206 of FIG. 24.

In FIG. 34, SCH reception processing section 406 employs a configuration including demultiplexing section 211, PSC sequence/sequence number specifying section 412, frame timing/cell ID group detecting section 213, precoding weight matrix specifying section 415 and channel estimating section 216.

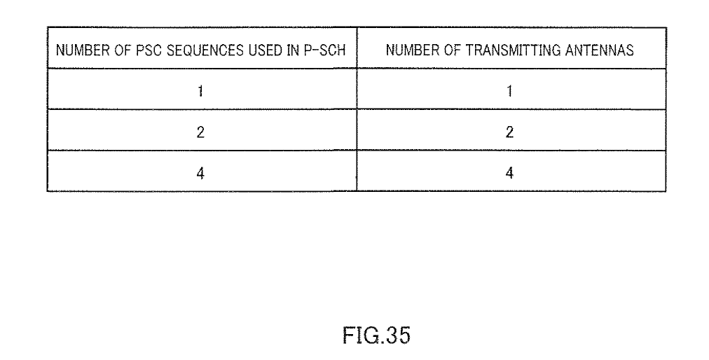

FIG. 35 shows a table listing an association of the number of PSC sequences with the number of transmitting antennas.

PSC sequence/sequence number specifying section 412 specifies PSC sequences and the number of PSC sequences used in a P-SCH using PSC sequence replicas. The number of PSC sequences are associated with the number of transmitting antennas on a one-by-one basis, and therefore, as shown in the table of FIG. 35, PSC sequence/sequence number specifying section 412 finds the number of transmitting antennas from the specified number of PSC sequences and outputs transmitting antenna number information.

Precoding weight matrix specifying section 415 specifies precoding weight matrices used in Node B 300 referring to the tables shown in FIG. 32 and FIG. 33 based on the PSC sequence information and transmitting antenna number information, and outputs precoding weight matrix information to channel estimating section 216.

As described above, according to the present embodiment, the number of transmitting antennas is specified by associating the number of transmitting antennas with the number of PSC sequences used in P-SCH and specifying the number of PSC sequences used for the received SCH signal, so that UE 400 can specify the number of transmitting antennas in the first step of cell search and receive SCHs to which PVS is applied, regardless of the number of transmitting antennas of Node B 300. Further, similar to Embodiment 1, by associating the precoding weight matrices with PSC sequences, it is possible to estimate channels from transmitting antennas using S-SCHs. As described above, the precoding weight matrices and the number of transmitting antennas can be specified, so that it is possible to accurately estimate channels from transmitting antennas. Further, it is not necessary to report the number of transmitting antennas in P-BCHs and S-SCHs. Furthermore, bits for reporting the number of transmitting antennas by means of P-BCHs and S-SCHs are not necessary.

The above explanation is an illustration of preferable embodiments of the present invention, and the scope of the present invention is not limited to this.

Although, with the above embodiments, a P-BCH channel estimating method and transmitting antenna detecting method have been explained in case where PVS is applied as SCH transmission diversity, it goes without saying that the present invention is not limited to P-BCHs. Similarly, the present invention is not limited to P-BCHs using SFBC.

Further, although cases have been explained with the above embodiments as examples where synchronized channel sequences are PSC sequences used in P-SCHs, it is possible to provide the same advantage by applying the present invention to other synchronized channel sequences. Note that the current communication systems such as 3G and 3.9G systems can specify PSC sequences in the first step of cell search by using PSC sequences. Accordingly, precoding weight matrices of PVS and transmitting antenna number information are specified in the first step of cell search, so that the present invention is advantageous in terms of the margin of subsequent processings and effective use of these items of information.

Further, a mode is possible where the base station apparatus and mobile station apparatus according to the above embodiments use one of (1) a channel estimating method by identifying precoding weight matrices and (2) specifying the number of transmitting antennas. In this case, a configuration is possible where the above (1) and (2) are used in combination or switched adequately depending on how UE is implemented.

Further, although the base station apparatus and mobile station apparatus have been explained with the above embodiments, these are only examples, and the present invention is applicable to any apparatus as long as it performs radio communication, and the type and the number of communication schemes are not limited.

Furthermore, the same applies to the number of base station apparatuses and the number of mobile station apparatuses.

Still further, although the names “base station apparatus,” “mobile station apparatus,” “communication system,” “channel estimating method” and “transmitting antenna detecting method” have been used with the above embodiments for ease of explanation, names such as “multicarrier transmitting/receiving apparatus” and “radio communication method” are also possible.

Any type, number and connecting method of each component such as a transmitting section, receiving section and storing section forming the above base station apparatus, mobile station apparatus and communication system are possible.

The above-explained base station apparatus, mobile station apparatus and communication system are implemented by the program for functioning these base station apparatus, mobile station apparatus and communication system. This program is stored in a computer-readable recording medium.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-26111, filed on Sep. 28, 2007, including the specification, drawings and abstract, is incorporated herein by reference in its entirety.

### INDUSTRIAL APPLICABILITY

The base station apparatus, mobile station apparatus, communication system, channel estimating method and transmitting antenna detecting method according to the present invention are useful for a base station apparatus, mobile station apparatus, channel estimating method and transmitting antenna detecting method applied in multicarrier communication of a mobile communication system.

1-15. (canceled)

16. A base station apparatus that performs multicarrier communication, the base station apparatus comprising:
a synchronization channel sequence generating section that generates synchronization channel sequences; and
a subcarrier group generating section that associates a number of transmitting antennas with a periodicity and/or a number of subcarriers of a subearrier group, and that generates, for multicarrier signal, the subcarrier group formed with a plurality of subcarriers by grouping synchronization channel sequences based on the periodicity and/or the number of subcarriers associated with the number of transmitting antennas, and outputs the subcarrier group.

17. The base station apparatus according to claim 16, further comprising a precoding weight matrix generating section that sets a plurality of synchronization channel sequences uniquely associated with precoding weight matrices that vary between subcarrier groups, and generates the precoding weight matrices associated with the plurality of set synchronization channel sequences.

18. The base station apparatus according to claim 17, further comprising a transmission diversity section that applies precoding vector switching to a frequency domain of a synchronization channel using the precoding weight matrices.

19. The base station apparatus according to claim 16, wherein the synchronization channel sequence comprises a primary synchronization code sequence used in a primary synchronization channel.

20. A mobile station apparatus comprising:
a receiving section that receives a multicarrier signal transmitted from a base station apparatus;
a detecting section that detects synchronization channel sequences from the received multicarrier signal; and
an auto-correlation section that finds auto-correlation characteristics of the detected synchronization channel sequences; and a transmitting antenna number specifying section that specifies a number of transmitting antennas associated with a periodicity and/or a number of subcarriers assigned to a subcarrier group formed with a plurality of subcarriers, based on a periodicity of the auto-correlation characteristics.

21. The mobile station apparatus according to claim 20, further comprising a precoding weight matrix specifying section that specifies precoding weight matrices associated uniquely with the synchronization channel sequences, from the detected synchronization channel sequences.

22. The mobile station apparatus according to claim 20, wherein the receiving section receives a synchronization channel to which precoding vector switching is applied.

23. The mobile station apparatus according to claim 20, wherein the synchronization channel sequences comprise primary synchronization code sequences used in a primary synchronization channel.

24. The mobile station apparatus according to claim 21, further comprising a channel estimating section that estimates a channel based on the specified precoding weight matrices.

25. The mobile station apparatus according to claim 20, further comprising a channel estimating section that estimates a channel based on the specified number of transmitting antennas.

26. A subcarrier group generating method in a base station apparatus that performs multicarrier communication, the subcarrier group generating method comprising the steps of:
generating synchronization channel sequences;
associating a number of transmitting antennas with a periodicity and/or a number of subcarriers of a subcarrier group; and
generating, for multicarrier signal, the subcarrier group formed with a plurality of subcarriers by grouping the synchronization channel sequences based on the periodicity and/or the number of subcarriers associated with the number of transmitting antennas, and outputting the subcarrier group.

27. A transmitting antenna detecting method comprising the steps of:
receiving a multicarrier signal transmitted from a base station apparatus;
detecting synchronization channel sequences from the received multicarrier signal;
finding auto-correlation characteristics of the detected synchronization channel sequences; and
specifying a number of transmitting antennas associated with a periodicity and/or a number of subcarriers assigned to a subearrier group formed with a plurality of subcarriers, based on a periodicity of the auto-correlation characteristics.
